(19) United States
(12) Patent Application Publication
(10) Pub. No.: US 2026/0213897 A1
(43) Pub. Date: Jul. 23, 2026

(54) INTERFERENCE HANDLING FOR NEIGHBORING WIRELESS DEVICES

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 19/030,225

(22) Filed: Jan. 17, 2025

(51) Int. Cl. H04L 5/00; H04W 24/08

(52) U.S. Cl. CPC H04L 5/0048; H04W 24/08

(57) ABSTRACT

Various aspects of the present disclosure generally relate to wireless communication. In some aspects, a victim network node may obtain, from a neighboring network node, an indication of uplink resource information associated with an aggressor user equipment (UE) serviced by the neighboring network node. The victim network node may measure an uplink interference level caused by the aggressor UE in accordance with the uplink resource information. Numerous other aspects are described.

### FIELD OF THE DISCLOSURE

Aspects of the present disclosure generally relate to wireless communication and specifically relate to techniques, apparatuses, and methods associated with interference handling for neighboring wireless devices.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples of wireless communications, one or more network nodes and/or user equipments (UEs) may experience various types of interference. For example, one or more wireless devices may experience cross-link interference (CLI). CLI may occur if uplink transmissions from one UE interfere with downlink reception at another UE. Additionally, CLI can arise in various scenarios, including inter-UE inter-cell CLI, inter-UE intra-cell CLI, and inter-network node CLI. Inter-UE inter-cell CLI may occur when a UE transmitting uplink in one cell interferes with a UE receiving downlink in a neighboring cell (e.g., typically due to overlapping frequency and time resources between cells). Inter-UE intra-cell CLI may occur within the same cell when one UE uplink transmission interferes with another UE downlink reception (e.g., often in dense deployments or shared resource scenarios). Inter-network node CLI may occur between uplink and downlink transmissions across gNBs (e.g., multiple network nodes), particularly in uncoordinated or dynamically shared spectrum environments, where different uplink and downlink configurations are used.

### SUMMARY

Some aspects described herein relate to a victim network node for wireless communication. The victim network node may include one or more memories and one or more processors coupled to the one or more memories. The one or more processors may be configured to obtain, from a neighboring network node, an indication of uplink resource information associated with an aggressor user equipment (UE) serviced by the neighboring network node. The one or more processors may be configured to measure an uplink interference level caused by the aggressor UE in accordance with the uplink resource information.

Some aspects described herein relate to a neighboring network node for wireless communication. The neighboring network node may include one or more memories and one or more processors coupled to the one or more memories. The one or more processors may be configured to output, to a victim network node, an indication of uplink resource information associated with an aggressor UE serviced by the neighboring network node, wherein the uplink resource information is associated measurement of an uplink interference level caused by the aggressor UE at the victim network node.

Some aspects described herein relate to an aggressor UE for wireless communication. The aggressor UE may include one or more memories and one or more processors coupled to the one or more memories. The one or more processors may be configured to transmit an uplink transmission associated with determination of an uplink interference level caused by the aggressor UE at a victim network node, wherein the aggressor UE is serviced by a neighboring network node that neighbors the victim network node.

Some aspects described herein relate to a method of wireless communication performed by a victim network node. The method may include obtaining, from a neighboring network node, an indication of uplink resource information associated with an aggressor UE serviced by the neighboring network node. The method may include measuring an uplink interference level caused by the aggressor UE in accordance with the uplink resource information.

Some aspects described herein relate to a method of wireless communication performed by a neighboring network node. The method may include outputting, to a victim network node, an indication of uplink resource information associated with an aggressor UE serviced by the neighboring network node, wherein the uplink resource information is associated measurement of an uplink interference level caused by the aggressor UE at the victim network node.

Some aspects described herein relate to a method of wireless communication performed by an aggressor UE. The method may include transmitting an uplink transmission associated with determination of an uplink interference level caused by the aggressor UE at a victim network node, wherein the aggressor UE is serviced by a neighboring network node that neighbors the victim network node.

Some aspects described herein relate to a non-transitory computer-readable medium that stores a set of instructions for wireless communication by a victim network node. The set of instructions, when executed by one or more processors of the victim network node, may cause the victim network node to obtain, from a neighboring network node, an indication of uplink resource information associated with an aggressor UE serviced by the neighboring network node. The set of instructions, when executed by one or more processors of the victim network node, may cause the victim network node to measure an uplink interference level caused by the aggressor UE in accordance with the uplink resource information.

Some aspects described herein relate to a non-transitory computer-readable medium that stores a set of instructions for wireless communication by a neighboring network node. The set of instructions, when executed by one or more processors of the neighboring network node, may cause the neighboring network node to output, to a victim network node, an indication of uplink resource information associated with an aggressor UE serviced by the neighboring network node, wherein the uplink resource information is associated measurement of an uplink interference level caused by the aggressor UE at the victim network node.

Some aspects described herein relate to a non-transitory computer-readable medium that stores a set of instructions for wireless communication by a one or more instructions. The set of instructions, when executed by one or more processors of an aggressor UE, may cause the aggressor UE to transmit an uplink transmission associated with determination of an uplink interference level caused by the aggressor UE at a victim network node, wherein the aggressor UE is serviced by a neighboring network node that neighbors the victim network node.

Some aspects described herein relate to an apparatus for wireless communication. The apparatus may include means for obtaining, from a neighboring network node, an indication of uplink resource information associated with an aggressor UE serviced by the neighboring network node. The apparatus may include means for measuring an uplink interference level caused by the aggressor UE in accordance with the uplink resource information.

Some aspects described herein relate to an apparatus for wireless communication. The apparatus may include means for outputting, to a victim network node, an indication of uplink resource information associated with an aggressor UE serviced by the neighboring network node, wherein the uplink resource information is associated measurement of an uplink interference level caused by the aggressor UE at the victim network node.

Some aspects described herein relate to an apparatus for wireless communication. The apparatus may include means for transmitting an uplink transmission associated with determination of an uplink interference level caused by the aggressor UE at a victim network node, wherein the aggressor UE is serviced by a neighboring network node that neighbors the victim network node.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of full-duplex communication in a wireless network, in accordance with the present disclosure.

FIG. 4 is a diagram illustrating examples of full-duplex deployment scenarios in which cross-link interface (CLI) and/or self-interference may occur, in accordance with the present disclosure.

FIG. 5 is a diagram illustrating examples of different duplexing modes, in accordance with the present disclosure.

FIG. 6 is a diagram illustrating an example of physical channels and reference signals in a wireless network, in accordance with the present disclosure.

FIGS. 7A and 7B are diagrams illustrating examples of inter-cell CLI and intra-cell CLI that may occur in dynamic time division duplex (TDD) and/or full-duplex deployment scenarios, in accordance with the present disclosure.

FIG. 8 is a diagram illustrating an example in accordance with measuring interference at a victim network node caused by an aggressor user equipment (UE), in accordance with the present disclosure.

FIG. 9 is a diagram illustrating an example associated with a victim network node adjusting timing to measure interference caused by an aggressor UE, in accordance with the present disclosure.

FIG. 10 is a diagram illustrating an example associated with an aggressor UE adjusting transmit timing for a victim network node to measure interference, in accordance with the present disclosure.

FIG. 11 is a diagram illustrating an example associated with a special sequence exchange used in accordance with measuring interference caused by an aggressor UE, in accordance with the present disclosure.

FIG. 12 is a diagram illustrating an example associated with a reference signal configuration used in accordance with measuring interference caused by an aggressor UE, in accordance with the present disclosure.

FIG. 13 is a diagram illustrating an example associated with a network node information exchange for mitigation of uplink interference caused by an aggressor UE, in accordance with the present disclosure.

FIG. 14 is a diagram illustrating an example associated with estimating downlink interference at an aggressor UE caused by a victim network node, in accordance with the present disclosure.

FIG. 15 is a diagram illustrating an example process performed, for example, at a victim network node or an apparatus of a victim network node, in accordance with the present disclosure.

FIG. 16 is a diagram illustrating an example process performed, for example, at a neighboring network node or an apparatus of a neighboring network node, in accordance with the present disclosure.

FIG. 17 is a diagram illustrating an example process performed, for example, at a UE or an apparatus of a UE, in accordance with the present disclosure.

FIG. 18 is a diagram of an example apparatus for wireless communication, in accordance with the present disclosure.

FIG. 19 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications, one or more network nodes and/or user equipments (UEs) may experience various types of interference. For example, one or more wireless devices may experience cross-link interference (CLI). CLI may occur if uplink transmissions from one UE interfere with downlink reception at another UE. Additionally, CLI can arise in various scenarios, including inter-UE inter-cell CLI, inter-UE intra-cell CLI, and inter-network node CLI. Inter-UE inter-cell CLI may occur when a UE transmitting uplink in one cell interferes with a UE receiving downlink in a neighboring cell (e.g., typically due to overlapping frequency and time resources between cells). Inter-UE intra-cell CLI may occur within the same cell when one UE uplink transmission interferes with another UE downlink reception (e.g., often in dense deployments or shared resource scenarios). Inter-network node CLI may refer to interference between uplink and downlink transmissions across gNBs (e.g., multiple network nodes), particularly in uncoordinated or dynamically shared spectrum environments, where different uplink and downlink configurations are used. In some examples, CLI can degrade signal quality, reduce data rates, and increase retransmissions.

In some examples, one or more wireless devices may transmit reference signals to mitigate CLI. For example, a first UE (e.g., an aggressor UE) may transmit an inter-UE CLI measurement transmission to a second UE (e.g., a victim UE). Accordingly, the victim UE may measure the resources of the inter-UE CLI measurement transmission to determine a level of interference at the victim UE caused by the aggressor UE. Therefore, the victim UE and/or the aggressor UE may select future transmission and reception resources that may reduce the inter-UE CLI. Additionally, a first network node (e.g., an aggressor network node) may transmit to a second network node (e.g., a victim network node) an inter-network node CLI measurement. The victim network node may measure the resources of the inter-network node CLI measurement transmission to determine a level of interference at the victim network node caused by the aggressor network node. Therefore, the victim network node and/or the aggressor network node may select future transmission and reception resources that may reduce the inter-network node CLI.

In some examples, one or more UEs described herein may be one or more customer premises equipment (CPE). For instance, a CPE may be a fixed or low-mobility wireless device located at a home or business premises that connects to a network of a telecommunications service provider (e.g., a laptop, a modem, a router, and/or a gateway, among other examples). In some examples, an aggressor UE may cause interference at one or more victim network nodes. For example, if the aggressor UE is a CPE, then the aggressor UE may be associated with a larger antenna panel as compared to other UE types (e.g., mobile UEs). Further, as the maximum power output capability of the aggressor UE may increase, which may result in an interference at a victim network node that is performing uplink reception. In some examples, such uplink interference may be referred to herein as “UE-to-network-node uplink interference” and/or “uplink interference level caused by an aggressor UE.” Therefore, one or more uplink transmissions from an aggressor UE may cause uplink interference at a victim network node, which may reduce signal quality at the victim network node. Such reductions in signal quality may result in increases in uplink retransmissions, which may increase signaling overhead and reduce network resource utilization.

Various aspects relate generally to a victim network node measuring an uplink interference level caused by the aggressor UE. Some aspects more specifically relate to a victim network node obtaining, from a neighboring network node, an indication of uplink resource information associated with one or more uplink transmissions configured for an aggressor UE (e.g., a CPE) serviced by the neighboring network node. For example, the uplink resource information may include one or more of CLI measurement resources for one or more inter-UE CLI measurement transmissions from the aggressor UE, sounding reference signal (SRS) resources for one or more SRS transmissions from the aggressor UE, configured grant (CG) resources for one or more CG uplink transmissions from the aggressor UE, uplink resources for an uplink data channel transmission from the aggressor UE, or uplink resources for an uplink reference signal transmission from the aggressor UE. Therefore, the victim network node may measure for uplink interference caused by the aggressor UE during one or more uplink resources indicated in the uplink resource information. In accordance with measuring the uplink interference, the victim network node may adjust one or more uplink reception operations to reduce uplink interference caused by the aggressor UE. For instance, the victim network node may switch to a reception beam associated with a lower-uplink interference, request the neighboring network node to avoid scheduling the aggressor UE with uplink transmissions during one or more uplink resources, and/or request the aggressor UE to reduce a transmission power and/or a transmission beam during one or more uplink resources. In some aspects, the victim network node may use the measured uplink interference caused by the aggressor UE to estimate a downlink interference caused by the victim network node at the aggressor UE. Accordingly, the victim network node may adjust one or more downlink transmission operations in order to reduce downlink interference at the aggressor UE caused by the victim network node.

Particular aspects of the subject matter described in this disclosure can be implemented to realize one or more of the following potential advantages. In some examples, the described techniques can be used to measure uplink interference at the victim network node without increasing signaling overhead. For example, based on the victim network node measuring uplink transmissions from the aggressor UE that are already configured, the victim network node may measure the uplink interference without introducing additional signaling. In some aspects, the described techniques may enable the victim network node to reduce uplink interference caused by the aggressor UE, which may increase signal quality at the victim network node for receiving uplink transmissions. Additionally, by leveraging the measured uplink interference at the victim network node caused by the aggressor UE to estimate the downlink interference at the aggressor UE caused by the victim network node, the victim network node may reduce downlink interference at the aggressor UE without increasing signaling overhead.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

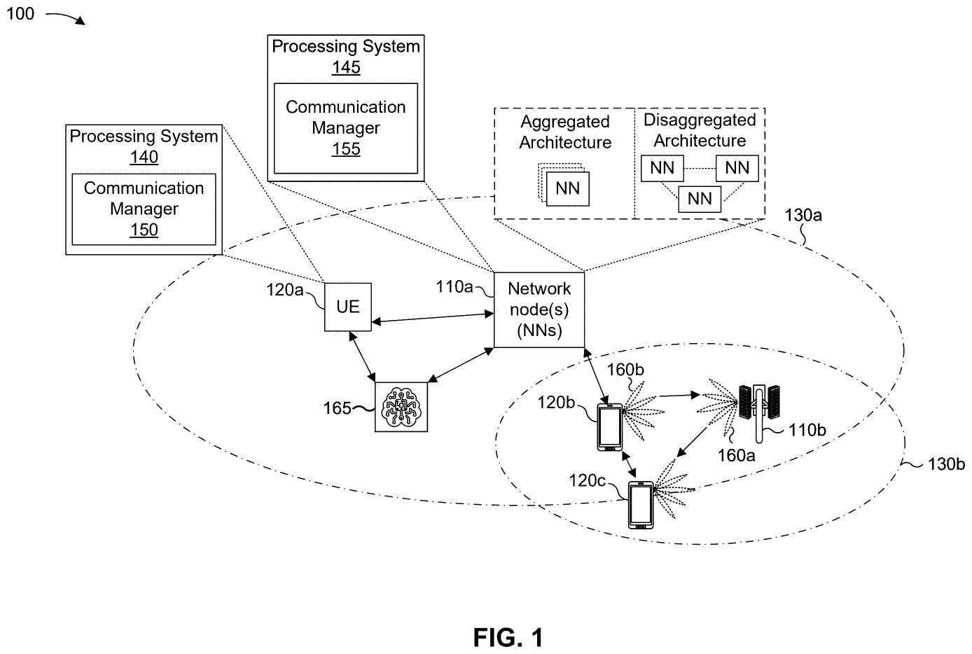

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

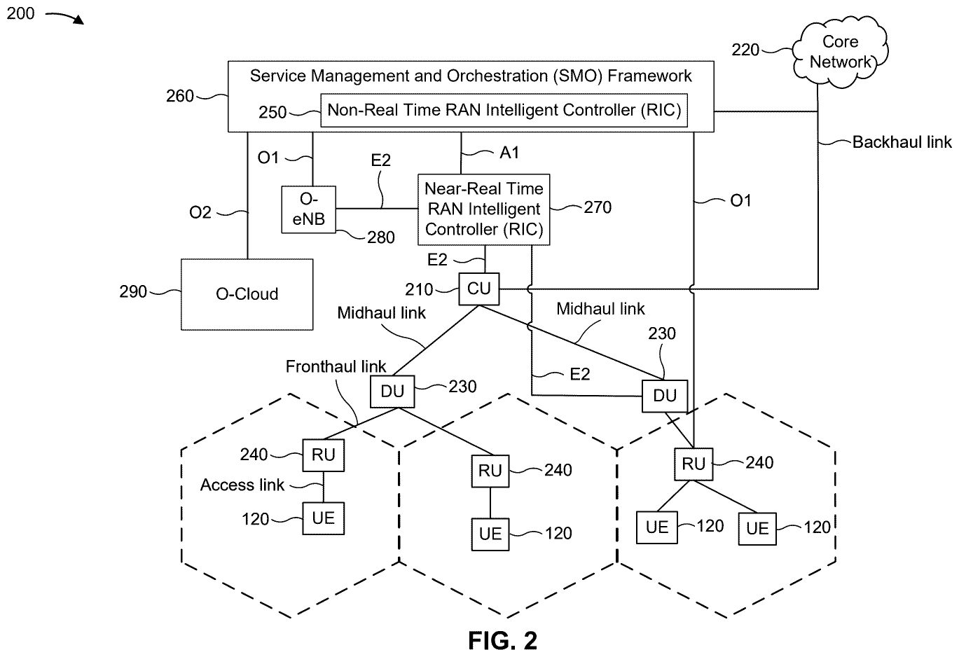

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the network node 110 may include a communication manager 155. As described in more detail elsewhere herein, the communication manager 155 may obtain, from a neighboring network node, an indication of uplink resource information associated with an aggressor UE serviced by the neighboring network node; and measure an uplink interference level caused by the aggressor UE in accordance with the uplink resource information.

Additionally, or alternatively, the communication manager 155 may output, to a victim network node, an indication of uplink resource information associated with an aggressor UE serviced by the neighboring network node, wherein the uplink resource information is associated measurement of an uplink interference level caused by the aggressor UE at the victim network node. Additionally, or alternatively, the communication manager 155 may perform one or more other operations described herein.

In some aspects, the UE 120 may include a communication manager 150. As described in more detail elsewhere herein, the communication manager 150 may transmit an uplink transmission associated with determination of an uplink interference level caused by the aggressor UE at a victim network node, wherein the aggressor UE is serviced by a neighboring network node that neighbors the victim network node. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

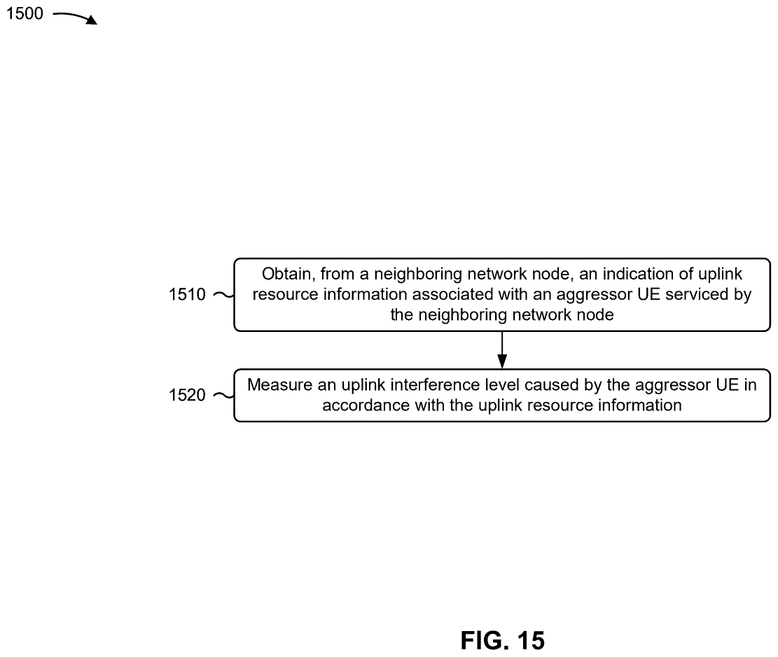

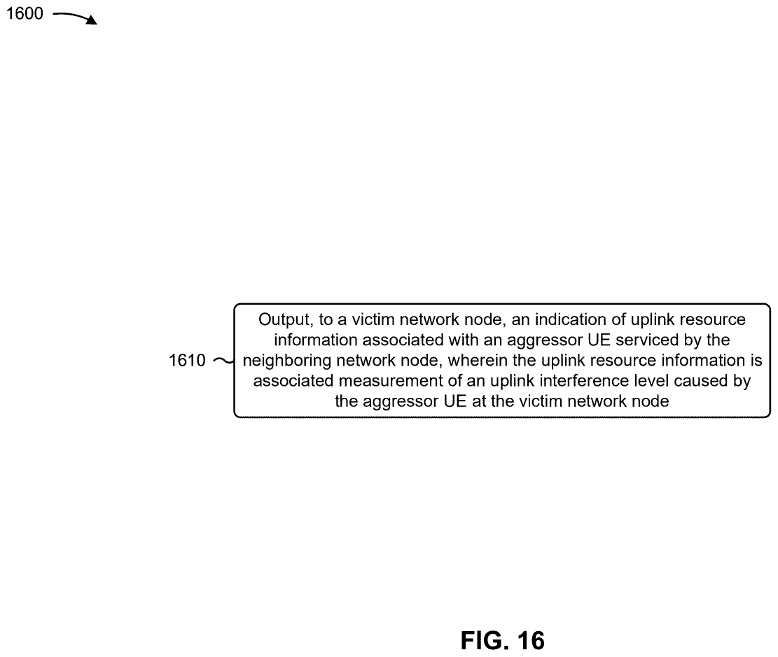

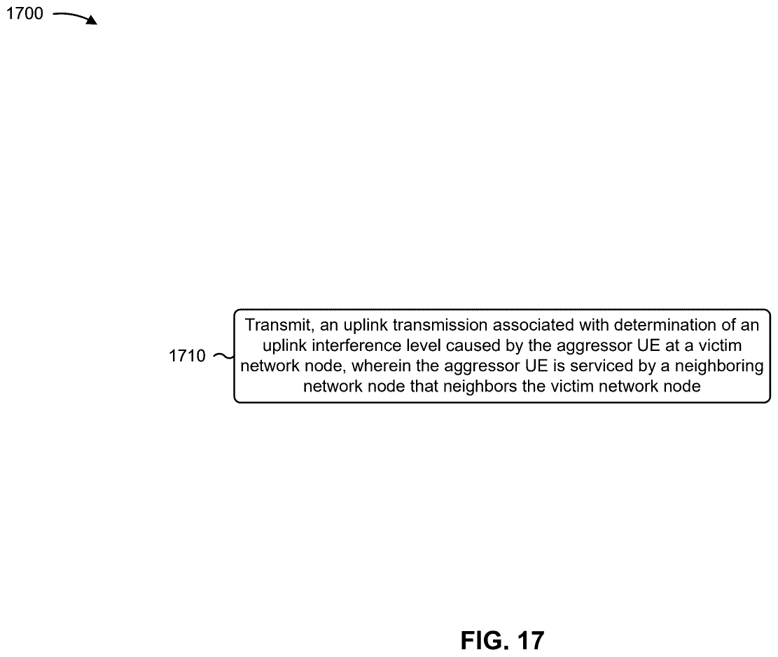

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with interference handling for neighboring wireless devices, as described in more detail elsewhere herein. For example, the processing system 145 of the network node 110, the processing system 140 of the UE 120, the CU 210, the DU 230, or the RU 240 may perform or direct operations of, for example, process 1500 of FIG. 15, process 1600 of FIG. 16, process 1700 of FIG. 17, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1500 of FIG. 15, process 1600 of FIG. 16, process 1700 of FIG. 17, or other processes as described herein. In some examples, executing instructions may include running the instructions, converting the instructions, compiling the instructions, and/or interpreting the instructions, among other examples.

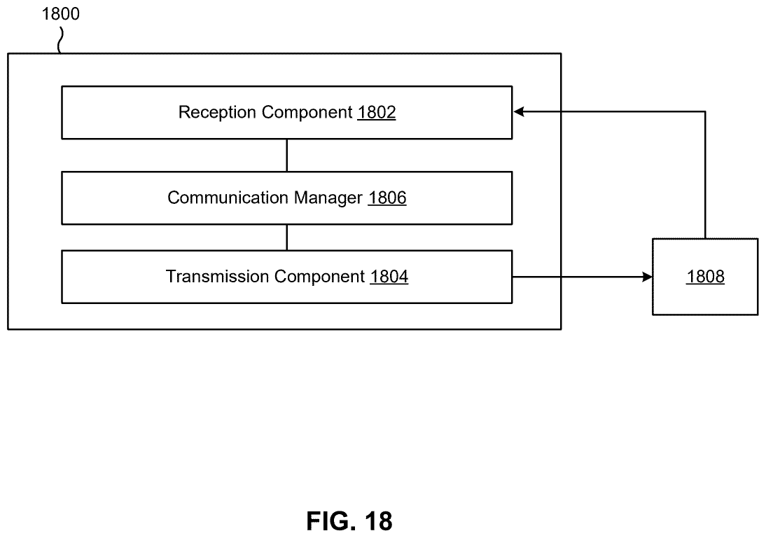

In some aspects, a victim network node includes means for obtaining, from a neighboring network node, an indication of uplink resource information associated with an aggressor UE serviced by the neighboring network node; and/or means for measuring an uplink interference level caused by the aggressor UE in accordance with the uplink resource information. The means for the victim network node to perform operations described herein may include, for example, one or more of communication manager 155, processing system 145, a radio, one or more RF chains, one or more transceivers, one or more antennas, one or more modems, a reception component (for example, reception component 1802 depicted and described in connection with FIG. 18), and/or a transmission component (for example, transmission component 1804 depicted and described in connection with FIG. 18), among other examples.

In some aspects, a neighboring network node includes means for outputting, to a victim network node, an indication of uplink resource information associated with an aggressor UE serviced by the neighboring network node, wherein the uplink resource information is associated measurement of an uplink interference level caused by the aggressor UE at the victim network node. The means for the neighboring network node to perform operations described herein may include, for example, one or more of communication manager 155, processing system 145, a radio, one or more RF chains, one or more transceivers, one or more antennas, one or more modems, a reception component (for example, reception component 1802 depicted and described in connection with FIG. 18), and/or a transmission component (for example, transmission component 1804 depicted and described in connection with FIG. 18), among other examples.

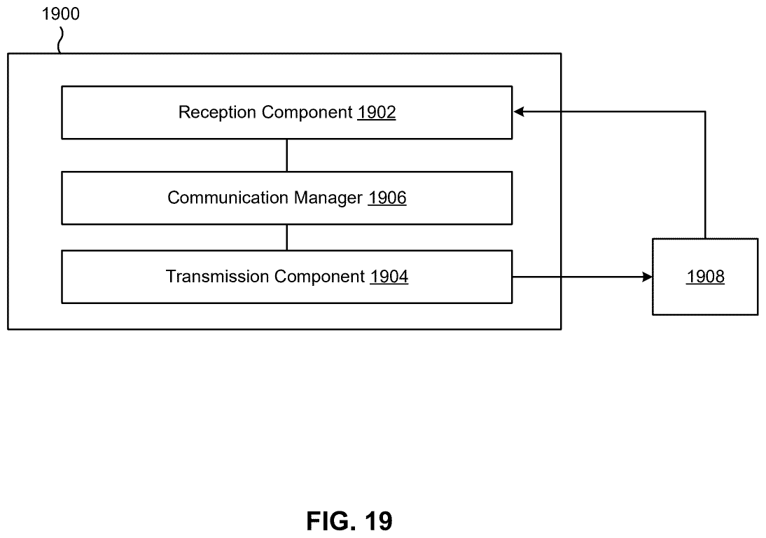

In some aspects, an aggressor UE includes means for transmitting an uplink transmission associated with determination of an uplink interference level caused by the aggressor UE at a victim network node, wherein the aggressor UE is serviced by a neighboring network node that neighbors the victim network node. The means for the aggressor UE to perform operations described herein may include, for example, one or more of communication manager 150, processing system 140, a radio, one or more RF chains, one or more transceivers, one or more antennas, one or more modems, a reception component (for example, reception component 1902 depicted and described in connection with FIG. 19), and/or a transmission component (for example, transmission component 1904 depicted and described in connection with FIG. 19), among other examples.

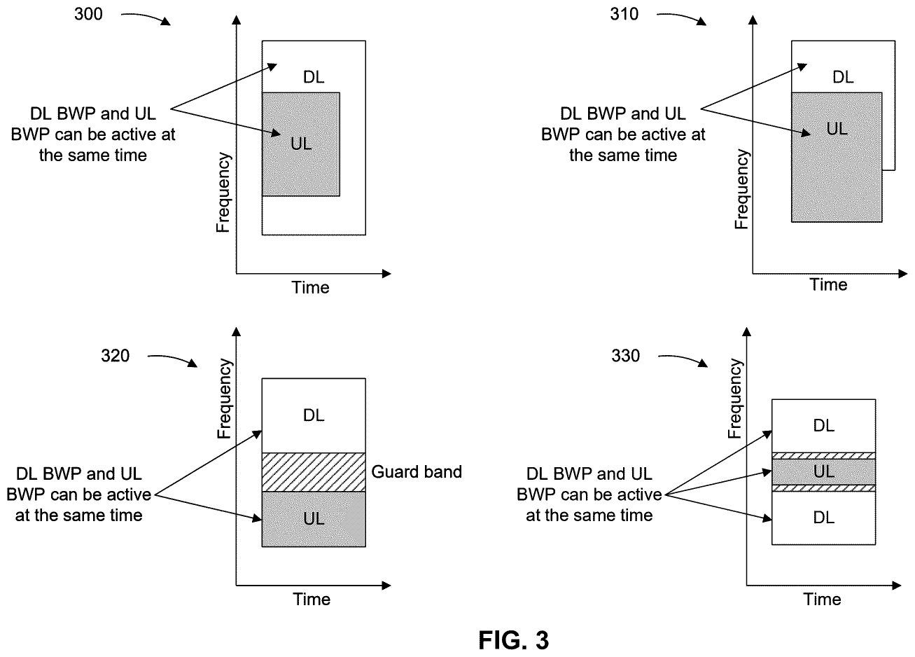

FIG. 3 is a diagram illustrating examples 300, 310, 320, 330 of full-duplex communication in a wireless network in accordance with the present disclosure. As described herein, “full-duplex communication” generally refers to simultaneous uplink and downlink communication in a wireless network, which may be a capability of a UE, a network node, or another suitable device. For example, a UE operating in a full-duplex mode may transmit an uplink communication and receive a downlink communication at the same time (for example, in the same slot or the same symbol) and/or a network node operating in a full-duplex mode may receive an uplink communication and transmit a downlink communication at the same time. “Half-duplex communication” in a wireless network generally refers to unidirectional communications (for example, only downlink communication or only uplink communication) at a given time (for example, a device only transmits or only receives in a given slot or a given symbol).

As shown in FIG. 3, examples 300 and 310 show examples of in-band full-duplex (IBFD) communication. In an IBFD communication scenario, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication (for example, all time and frequency resources allocated to uplink communication are also available for downlink communication). As shown in example 310, in a second example of IBFD, the time and frequency resources for uplink communication may partially overlap with the time and frequency resources for downlink communication (for example, some time and frequency resources are reserved for uplink communication only).

As further shown in FIG. 3, examples 320 and 330 show SBFD communication, which may also be referred to as “sub-band frequency division duplex (SBFDD),” “flexible duplex,” or “full division duplex (FDD) in unpaired spectrum.” In an SBFD configuration, a UE may transmit an uplink communication to a network node and receive a downlink communication from the network node at the same time, but on different frequency resources. For example, the different frequency resources may be sub-bands of a frequency band, such as a TDD band. In such examples, the frequency resources used for downlink communication may be separated from the frequency resources used for uplink communication, in the frequency domain, by a guard band. For example, as shown by example 320, an SBFD configuration may include a downlink bandwidth part and an uplink bandwidth part that can be active at the same time, where a guard band separates the downlink bandwidth part and the uplink bandwidth (for example, to prevent interference). Additionally or alternatively, as shown by example 330, an SBFD configuration may include a first downlink bandwidth part, a second downlink bandwidth part, and an uplink bandwidth part provided between the first downlink bandwidth part and the second downlink bandwidth part, with a first guard band separating the uplink bandwidth part from the first downlink bandwidth part and a second guard band separating the uplink bandwidth part from the second downlink bandwidth part.

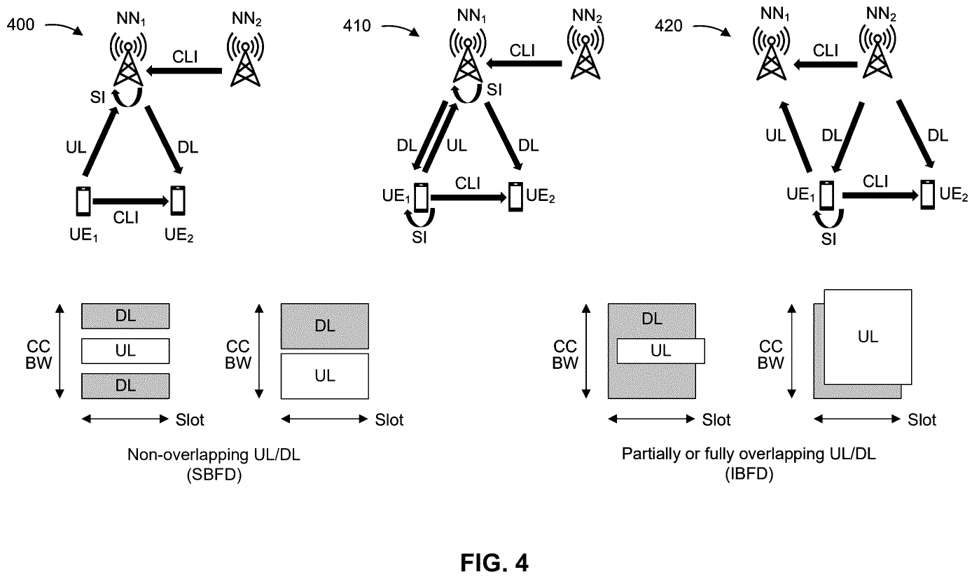

FIG. 4 is a diagram illustrating examples 400, 410, 420 of full-duplex deployment scenarios in which CLI and/or self-interference (SI) may occur in accordance with the present disclosure. As shown in FIG. 4, examples 400, 410, 420 include one or more UEs in communication with one or more network nodes in a wireless network that supports full-duplex communication. In general, as described herein, utilizing a full-duplexing communication mode may provide reduced latency by allowing a downlink transmission to occur in an uplink-only slot and/or by allowing an uplink transmission to occur in a downlink-only slot. In addition, full-duplex communication may enhance spectral efficiency or throughput per cell or per UE and/or enable more efficient resource utilization by simultaneously utilizing time and frequency resources for downlink and uplink communication. However, as described in further detail herein, full-duplexing communication modes may be associated with dynamic interference conditions.

For example, as shown in FIG. 4, example 400 includes a first UE (shown as UE1) and a second UE (shown as UE2) in communication with a first network node (shown as NN1) operating in a full-duplexing mode, with the first UE and the second UE operating in a half-duplexing mode. For example, as shown in FIG. 4, the first UE may transmit one or more uplink transmissions to the first network node, and the second UE may concurrently receive one or more downlink transmissions from the first network node. Accordingly, in example 400, the first network node is operating in a full-duplexing mode, and the first UE and the second UE are each operating in a half-duplexing mode. As shown by example 400, there may be various forms of interference that may degrade downlink reception performance at one or more UEs and/or uplink reception performance at the first network node operating in the full-duplexing mode. For example, as shown, the first network node may experience inter-cell CLI caused by downlink transmissions from a second network node (shown as NN2) that may be located in an adjacent or nearby cell. Furthermore, as shown, the uplink transmission from the first UE to the first network node may cause intra-cell CLI at the second UE (for example, CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port and/or when an object in a surrounding environment reflects a transmitted signal back to a receive port (for example, causing a clutter echo effect), thus interfering with reception of a desired signal at the receive port. In general, the full-duplexing mode used by the first network node in example 400 may be an SBFD mode, where a component carrier bandwidth is divided into non-overlapping uplink and downlink sub-bands.

As further shown in FIG. 4, in example 410, a first UE may communicate with a first network node in a full-duplexing mode. For example, in example 410, the first UE may receive one or more downlink transmissions from the first network node, and the first UE may concurrently transmit one or more uplink transmissions to the first network node. Accordingly, in example 410, the first network node and the first UE are both operating in a full-duplexing mode. Furthermore, as shown, the first network node may be communicating with a second UE operating in a half-duplex mode. As shown in FIG. 4, the first UE may experience self-interference, where the uplink transmission to the first network node interferes with reception of the downlink transmission from the first network node, and the first UE may cause cross-link interference at the second UE, where the uplink transmission to the first network node interferes with downlink reception at the second UE. Additionally, in example 410, the first network node may experience inter-cell CLI caused by one or more downlink transmissions from a second network node interfering with reception of the uplink transmission from the first UE, and the first network node may experience self-interference, where downlink transmission(s) to the first UE and/or the second UE interferes with reception of the uplink transmission from the first UE. In example 410, the full-duplex communication may be performed in an SBFD mode, where a component carrier bandwidth is divided into non-overlapping uplink and downlink sub-bands, or in an IBFD mode, where uplink and downlink resources fully or partially overlap.

As further shown in FIG. 4, in example 420, a first UE may communicate with a first network node and a second network node in a full-duplexing mode (for example, a multi-TRP mode). For example, in example 420, the first UE may transmit one or more uplink transmissions to the first network node, and the first UE may concurrently receive one or more downlink transmissions from the second network node. Accordingly, in example 420, the first UE is operating in a full-duplexing mode, and the first and second network nodes are both operating in a half-duplexing mode. As shown in FIG. 4, the first UE may experience self-interference, where the uplink transmission to the first network node interferes with reception of the downlink transmission from the second network node. Furthermore, the uplink transmission by the first UE may cause inter-UE CLI at a second UE that is receiving a downlink transmission from the second network node. Furthermore, as shown, the downlink transmission by the second network node may cause inter-cell CLI interfering with reception of the uplink transmission from the first UE at the first network node. In example 420, the full-duplex communication may be performed in an SBFD mode, where a component carrier bandwidth is divided into non-overlapping uplink and downlink sub-bands, or in an IBFD mode, where uplink and downlink resources fully or partially overlap.

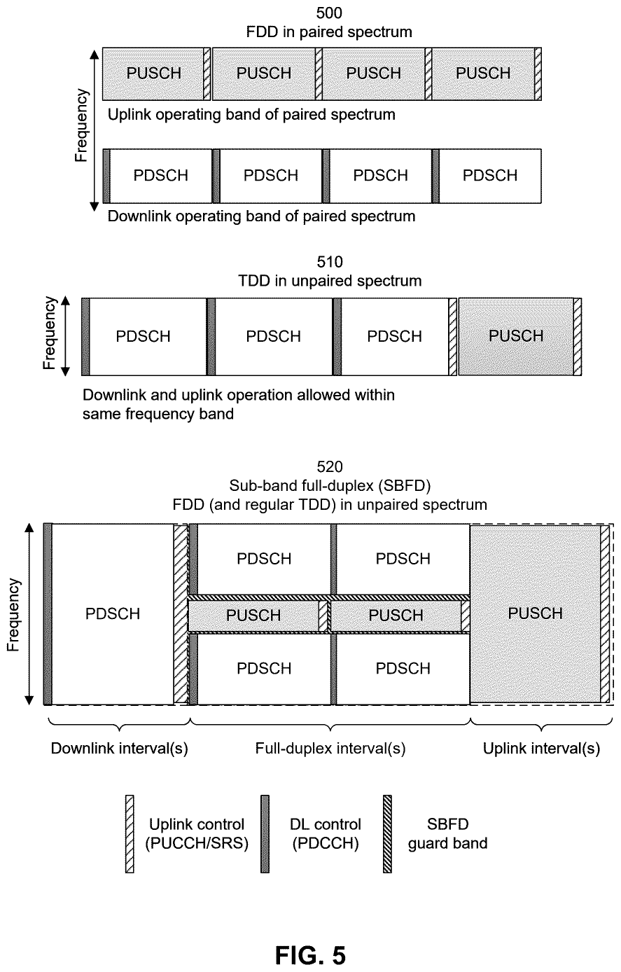

FIG. 5 is a diagram illustrating examples 500, 510, 520 of different duplexing modes in accordance with the present disclosure. For example, as described in further detail herein, FIG. 5 illustrates an example 500 of an FDD mode that may be used in paired spectrum, an example 510 of a TDD mode that may be used in unpaired spectrum, and an example 520 of an SBFD mode that may be used in unpaired spectrum. In general, a wireless communication standard and/or governing body may specify one or more duplexing modes in which a wireless spectrum is to be used. For example, 3GPP may specify how wireless spectrum is to be used for the 5G or NR RAT and interface. As an example, a specification may indicate whether a band is to be used as paired spectrum in an FDD mode, as unpaired spectrum in a TDD mode, or another mode.

For example, as shown by example 500, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP TS 38.101-1.

Alternatively, as shown by example 510, unpaired spectrum in the TDD mode may allow downlink and uplink operation within a single frequency region (for example, a single operating band). For example, when operating in TDD mode in unpaired spectrum, downlink communication and uplink communication may occur in the same frequency range. Some deployments may use TDD in the unpaired band, whereby some transmission time intervals (for example, frames, slots, and/or symbols) are used for downlink communication only and other transmission time intervals are used for uplink communication only. In such examples, substantially the entire bandwidth of a component carrier may be used for downlink communication or uplink communication, depending on whether the communication is performed in a downlink interval, an uplink interval, or a special interval (in which either downlink or uplink communication can be scheduled). Examples of unpaired bands include NR operating bands n40, n41, and n50, as specified by 3GPP TS 38.101-1. In some cases, however, using TDD in unpaired spectrum may be inefficient. For example, uplink transmit power may be limited, meaning that UEs may be incapable of transmitting with enough power to efficiently utilize the full bandwidth of an uplink slot. This may be particularly problematic in large cells at the cell edge. Furthermore, using TDD may introduce latency relative to a full-duplex scheme in which uplink communications and downlink communications can be performed in the same time interval, since TDD restricts usage of a given transmission time interval to uplink or downlink communication only. Furthermore, using TDD may reduce spectral efficiency and/or reduce throughput by restricting usage of a given transmission time interval to uplink or downlink communication only.

Accordingly, as shown by example 520, an unpaired band may be configured in a full-duplexing mode to enable concurrent transmit and receive operations in unpaired spectrum (for example, a TDD band). For example, in FIG. 5, example 520 depicts an SBFD mode, which may be referred to herein as full-duplexing in a frequency division multiplexing (FDM) mode, in order to enable TDD operation and/or FDD operation in unpaired spectrum. For example, as shown in FIG. 5, an unpaired band configured in the SBFD mode may associate one or more transmission time intervals with downlink communication only (for example, “D” slots), one or more transmission time intervals for uplink communication only (for example, “U” slots), and one or more transmission time intervals for both downlink communication and uplink communication (for example, “D+U” slots). Each transmission time interval may be associated with a control region, illustrated as a portion of a time interval with a diagonal fill for uplink control (for example, a PUCCH) or a darker-shaded fill for downlink control (for example, a PDCCH). Additionally or alternatively, each time interval may be associated with a data region, which is shown as a PDSCH for downlink frequency regions or a PUSCH for uplink frequency regions.

In some aspects, an unpaired band configured in the SBFD mode may include one or more downlink-only time intervals, one or more uplink-only time intervals, and/or one or more full-duplex time intervals (for example, frames, subframes, slots, and/or symbols, among other examples) that are associated with an FDD configuration. For example, as shown in FIG. 5, the FDD configuration associated with a full-duplex time interval may indicate one or more downlink frequency regions (or sub-bands) and one or more uplink frequency regions (or sub-bands) that are separated by a guard band. Accordingly, an FDD configuration may divide an unpaired frequency band (for example, one or more component carriers of an unpaired band) into uplink frequency regions, downlink frequency regions, and/or other regions (for example, guard bands), which may enable a UE with full-duplex capabilities to perform simultaneous transmit and receive operations during one or more time intervals that are divided into downlink and uplink sub-bands with a guard band separation to prevent the uplink transmission from causing self-interference with respect to downlink reception. For example, in a given full-duplex time interval, a half-duplexing UE may either transmit using the uplink frequency region or receive in the downlink frequency region (for example, a first UE communicating using half-duplexing may only receive in a lower downlink frequency region during the full-duplex time intervals), and a full-duplexing UE may transmit using the uplink frequency region and/or receive in the downlink frequency region (for example, a second UE communicating using full-duplexing may receive in an upper downlink frequency region simultaneous with transmission in an uplink frequency region during the full-duplex time intervals). In some aspects, the FDD configuration may identify bandwidth part configurations corresponding to the uplink frequency regions and the downlink frequency regions. For example, a respective bandwidth part may be configured for each uplink frequency region and each downlink frequency region.

Additionally or alternatively, full-duplexing may be enabled in unpaired spectrum in an IBFD mode, which may be referred to herein as full-duplexing in a spatial division multiplexing (SDM) mode. For example, in an IBFD or SDM mode, uplink communication may occur on time and frequency resources that fully overlap in time and frequency resources allocated to downlink communication (for example, all of the time and frequency resources available for uplink communication are also available for downlink communication), or uplink communication may occur on time and frequency resources that partially overlap with time and frequency resources available for downlink communication (for example, some time and frequency resources available for uplink communication are also available for downlink communication and some time and frequency resources available for uplink communication are uplink-only). In general, in the IBFD mode, full-duplex communication may be conditional on sufficient beam separation between an uplink beam and a downlink beam (for example, uplink transmission may be from one antenna panel and downlink reception may be in another antenna panel) to minimize self-interference that may occur when a transmitted signal leaks into a receive port and/or when an object in a surrounding environment reflects a transmitted signal back to a receive port (for example, causing a clutter echo effect).

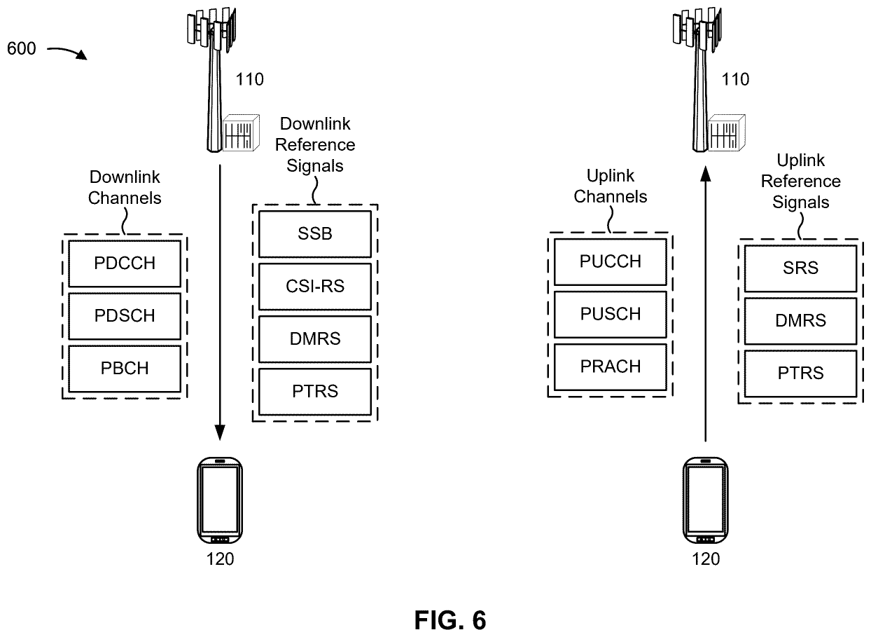

FIG. 6 is a diagram illustrating an example 600 of physical channels and reference signals in a wireless network, in accordance with the present disclosure. As shown in FIG. 6, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a SRS, a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error. As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 6 is provided as an example. Other examples may differ from what is described with regard to FIG. 6.

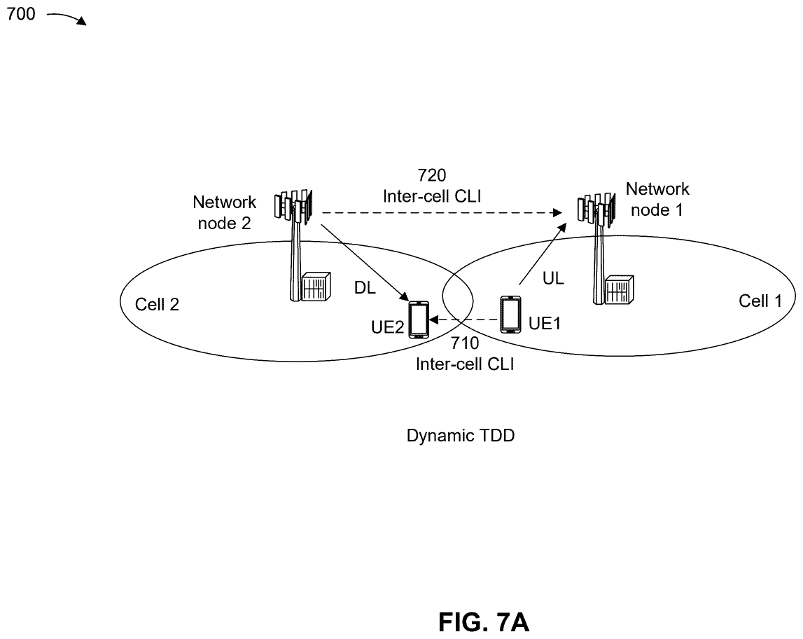

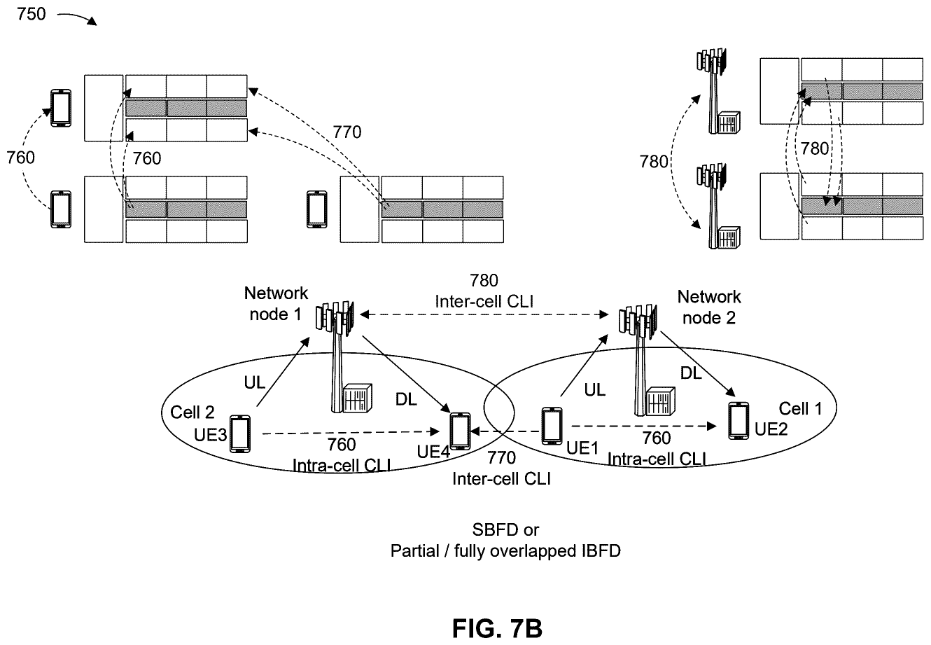

FIGS. 7A and 7B are diagrams illustrating examples 700, 750 of inter-cell CLI and intra-cell CLI that may occur in dynamic TDD and/or full-duplex deployment scenarios in accordance with the present disclosure. For example, referring to FIG. 7A, example 700 depicts dynamic TDD communication. As shown in example 700, when dynamic TDD is implemented, neighboring cells (for example, cell 1 and cell 2 in FIG. 7A) may use different TDD configurations to communicate with served UEs in the respective cells, which may result in an uplink communication between a first UE (UE1) and a first network node (network node 1) in a same TTI as a downlink communication between a second network node (network node 2) and a second UE (UE2). The concurrent uplink and downlink communications in different transmission directions (for example, downlink versus uplink) in the same TTI may interfere with one another, which may be referred to as CLI. Interference with reception of a downlink communication by a first UE caused by transmission of an uplink communication by a second UE may be referred to as UE-to-UE CLI or inter-UE CLI. For example, as shown by reference number 710 in the dynamic TDD scenario shown in FIG. 7A, transmission of the uplink communication in a symbol or a slot by UE1 in cell 1 may interfere with reception of the downlink communication in the symbol or the slot by UE2 in cell 2. Such interference may be referred to as inter-cell UE-to-UE CLI or inter-cell inter-UE CLI. Additionally or alternatively, as shown by reference number 720, transmission of the downlink communication in a symbol or a slot by the second network node in cell 2 may interfere with reception of the uplink communication in the symbol or the slot by the second network node in cell 2. Such interference may be referred to as inter-cell network node-to-network node CLI, inter-cell inter-network node CLI, or inter-network node CLI.

Referring to FIG. 7B, example 750 shows an example of full-duplex communication, such as SBFD, fully overlapping IBFD, or partially overlapping IBFD. As shown by reference number 760, in a full-duplex scenario, transmission of an uplink communication in an SBFD or IBFD slot or symbol by a first UE in a cell may interfere with reception of a downlink communication in the SBFD or IBFD slot or symbol by a second UE in the cell. For example, transmission of an uplink communication in an SBFD or IBFD slot or symbol by a first UE (UE1) in a first cell (cell 1) may interfere with reception of a downlink communication in the SBFD or IBFD slot or symbol by a second UE (UE2) in cell 1. As another example, transmission of an uplink communication in an SBFD or IBFD slot or symbol by a third UE (UE3) in a second cell (cell 2) may interfere with reception of a downlink communication in the SBFD or IBFD slot or symbol by a fourth UE (UE4) in cell 2. Such interference may be referred to as intra-cell UE-to-UE CLI or intra-cell inter-UE CLI. In an SBFD scenario, transmission of an uplink communication on an uplink sub-band (SB) in an SBFD symbol or slot by one UE (for example, UE1) in a cell (for example, cell 1) may interfere with reception of a downlink communication on a downlink SB in the SBFD symbol or slot by another UE (for example, UE2) in the cell. Such interference may be referred to as inter-SB intra-cell UE-to-UE CLI or inter-SB intra-cell inter-UE CLI. Additionally or alternatively, as shown by reference number 770, in a full-duplex scenario, transmission of an uplink communication in an SBFD or an IBFD symbol or slot by a first UE in a first cell may interfere with reception of a downlink communication in the SBFD or IBFD symbol or slot by a second UE in a second cell. Such interference may be referred to as inter-cell inter-UE CLI. In an SBFD scenario, transmission of an uplink communication on an uplink SB in an SBFD symbol or slot by a first UE in a first cell may interfere with reception of a downlink communication on a downlink SB in the SBFD symbol or slot by a second UE in a second cell. Such interference may be referred to as inter-SB inter-cell inter-UE CLI. Additionally or alternatively, as shown by reference number 780, transmission of a downlink communication in an SBFD or IBFD symbol or slot by a first network node in a first cell may interfere with reception of an uplink communication on an uplink SB in the SBFD or IBFD symbol or slot by a second network node in a second cell. Such interference may be referred to as inter-SB inter-cell inter-network node (or inter-network node) CLI.

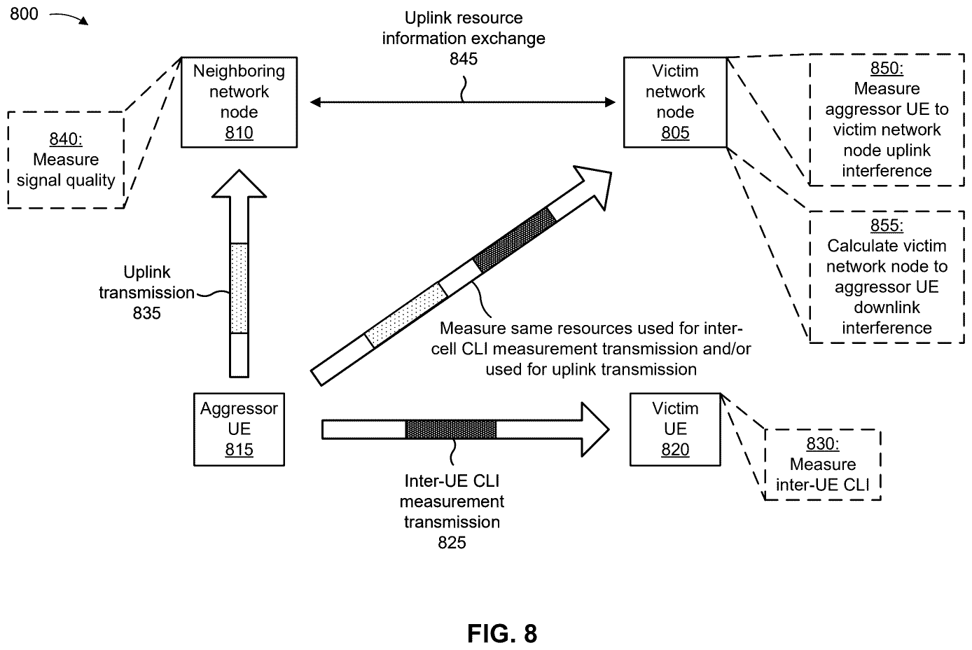

FIG. 8 is a diagram illustrating an example 800 in accordance with measuring interference at a victim network node caused by an aggressor UE, in accordance with the present disclosure. In some instances, example 800 may implement or be implemented by one or more aspects of FIGS. 1 through 7B. For example, FIG. 8 may illustrate wireless communications between a victim network node 805, a neighboring network node 810, an aggressor UE 815, and a victim UE 820. In some examples, the victim network node 805 and the neighboring network node 810 may be examples of any network node (e.g., network node 110) described elsewhere herein. In some examples, the aggressor UE 815 and victim UE 820 may be examples of any UE (e.g., UE 120) described elsewhere herein.

In some examples, the aggressor UE 815 and/or the victim UE 820 may be examples of respective CPEs. For example, “CPEs” may refer to fixed or low mobility wireless devices located at a home or business premises that connect to a network of a telecommunications service provider. CPE devices may serve as interfaces between an end-user and the network, which may enable internet access and/or other communication services. Additionally, a 5G CPE may be designed to utilize the ultra-high-speed and low-latency capabilities of 5G networks, which may enable the 5G CPE for use in a wide range of applications, including enhanced mobile broadband, fixed wireless access, and IoT use cases. CPEs can come in various forms, such as 5G-enabled modems, routers, or gateways, which can connect to devices within a local network.

In example 800, the victim network node 805 may service the victim UE 820. For example, the victim network node 805 may transmit, and the victim UE 820 may receive, downlink wireless messages (via downlink) and the victim UE 820 may transmit, and the victim network node 805 may receive, uplink wireless messages (via uplink). Additionally, in example 800, the neighboring network node 810 may service the aggressor UE 815. For example, the neighboring network node 810 may transmit, and the aggressor UE 815 may receive, downlink wireless messages (via downlink) and the aggressor UE 815 may transmit, and the neighboring network node 810 may receive, uplink wireless messages (via uplink).

In example 800, the neighboring network node 810 and the victim network node 805 may communicate via a backhaul link. For example, the backhaul link may facilitate communication between multiple network nodes, enabling the transfer of control-plane signaling and user-plane data. If the backhaul link is an F1 Application Protocol (F1AP) interface, then the backhaul link connects a CU and a DU within a gNB. Such an F1AP interface may support the split architecture of a gNB, where the CU may handle high-level functions, such as RRC, and the DU may manage lower-layer processing, including the physical layer. Over the F1AP interface, the CU and DU may exchange configuration and management information, such as session establishment, handover commands, and load balancing directives, which may enable a synchronized operation. Additionally, the F1AP interface may enable efficient user-plane data forwarding, maintaining low latency and high throughput within the gNB architecture. In some examples, the neighboring network node 810 may be the CU and the victim network node 805 may be the DU. Alternatively, the neighboring network node 810 may be the DU and the victim network node 805 may be the CU. If the backhaul link is an Xn interface, then the backhaul link connects two separate and/or different gNBs, enabling inter-network node communication for tasks like mobility management and load sharing. For example, if a wireless device moves out of the coverage area of a source gNB, the source gNB may use the Xn backhaul to communicate with a target gNB, facilitating a handover. In some examples, the handover may include one or more of transferring user-plane data, signaling related to resource allocation, or context information about the wireless device. Additionally, the Xn interface may support dual connectivity, enabling the wireless device to simultaneously connect to multiple gNBs for improved reliability and performance. Therefore, if the backhaul link is an Xn interface, then the neighboring network node 810 and the victim network node 805 may be respective gNBs.

In some examples, one or more of the wireless devices included in example 800 may experience different types of interference described elsewhere herein. For example, the victim UE 820 may experience inter-UE CLI caused by the aggressor UE 815. Such inter-UE CLI may include inter-cell inter-UE CLI, intra-cell inter-UE CLI, and/or inter-SB intra-cell inter-UE CLI in accordance with TDD, FDD, SBFD, and/or IBFD scenarios, as described elsewhere herein. To reduce the inter-UE CLI, the aggressor UE 815 may transmit, and the victim UE 820 may receive, an inter-UE CLI measurement transmission 825. In some examples, the inter-UE CLI measurement transmission 825 may be an SRS transmitted via an SRS-RSRP resource. For example, the aggressor UE 815 may transmit the SRS, via a configured SRS-RSRP resource, and the victim UE 820 may measure the RSRP associated with the SRS. Accordingly, as shown by reference number 830, the victim UE 820 can measure inter-UE CLI based on the RSRP associated with the SRS. In some examples, the inter-UE CLI measurement transmission 825 may be transmitted via a CLI-RSSI resource. For example, the CLI-RSSI resource may refer to an uplink resource designated for measuring the RSSI in the context of CLI. Therefore, the aggressor UE 815 may transmit the inter-UE CLI measurement transmission 825 via a CLI-RSSI resource, and the victim UE 820 may measure the RSSI associated with the inter-UE CLI measurement transmission 825. Accordingly, as shown by reference number 830, the victim UE 820 can measure inter-UE CLI based on the RSSI associated with the inter-UE CLI measurement transmission 825.

In some examples, the neighboring network node 810 and the victim network node 805 may configure a set of SRS-RSRP resources and/or a set of CLI-RSSI resources. For example, the neighboring network node 810 and the victim network node 805 may coordinate (via backhaul signaling) the set of SRS-RSRP resources and/or the set of CLI-RSSI resources. Accordingly, the neighboring network node 810 may transmit, and the aggressor UE 815 may receive, RRC signaling that indicates the set of SRS-RSRP resources and/or the set of CLI-RSSI resources, during which the aggressor UE 815 may transmit the inter-UE CLI measurement transmission 825. Additionally, the victim network node 805 may transmit, and the victim UE 820 may receive, RRC signaling that indicates the set of SRS-RSRP resources and/or the set of CLI-RSSI resources, during which the victim UE 820 may measure the inter-UE CLI (e.g., in accordance with reference number 830). In some examples, the inter-UE CLI measurement transmission 825 may implement or be implemented by an inter-UE CLI measurement framework, as defined in a wireless communications standard (such as the L3 and/or L1 inter-UE CLI measurement framework in 3GPP).

In some examples, the aggressor UE 815 may transmit, and the neighboring network node 810 may receive, an uplink transmission 835. In some examples, the uplink transmission 835 may be any type of uplink reference signal described herein (e.g., SRS, DMRS, and/or PTRS, as described with reference to FIG. 6). Accordingly, as shown by reference number 840, the neighboring network node 810 may measure a signal quality associated with receiving the uplink transmission 835 (e.g., RSRP, RSSI, or any other signal quality metric described elsewhere herein).

In some examples, the uplink transmission 835 may be a CG uplink transmission. For example, the neighboring network node 810 may transmit, and the aggressor UE 815 may receive, RRC signaling that configures the aggressor UE 815 with parameters for the CG uplink transmission (e.g., frequency and time-domain resources, transmission periodicity or occasions for the uplink transmission, a PUSCH configuration including MCS, and/or power control parameters). In some examples, the RRC signaling may indicate activation of the CG configuration or may specify one or more conditions under which the CG configuration may become active. In some examples, the neighboring network node 810 may transmit control information (e.g., via MAC-CE signaling or DCI signaling) to dynamically activate the CG configuration. Therefore, the aggressor UE 815 may transmit the uplink transmission 835 in accordance with the CG configuration. In some examples, the uplink transmission 835 may be any type of uplink transmission described herein.

In some examples, one or more wireless transmissions by the aggressor UE 815 may result in interference at the victim network node 805. For example, if the aggressor UE 815 is a CPE, then the aggressor UE 815 may be associated with a larger antenna panel as compared to other UE types (e.g., mobile UEs). Further, the maximum power output capability of the aggressor UE 815 may increase, which may result in an interference at the victim network node 805 for performing uplink reception. For example, if the aggressor UE 815 transmits a first uplink message to the neighboring network node 810, concurrently with the victim UE 820 transmitting a second uplink message to the victim network node 805, then the first uplink message may overlap with one or more uplink resources of the second uplink message. Therefore, as the power output level of the first uplink message increases (e.g., as enabled by the larger antenna panel), the uplink interference associated with receiving the second uplink message at the victim network node 805 may increase. Such uplink interference may be referred to herein as “UE-to-network node uplink interference” and/or “uplink interference level caused by an aggressor UE.”

In some examples, the victim network node 805 may reduce the UE-to-network node uplink interference. For example, as shown by reference number 850, the victim network node 805 may measure aggressor UE 815 to victim network node 805 uplink interference. As shown in FIG. 8, the victim network node 805 may measure the uplink interference level caused by the aggressor UE 815 in accordance with measuring the same resource used for the inter-UE CLI measurement transmission 825 and/or the uplink transmission 835. In other words, the victim network node 805 may leverage and/or reuse the one or more uplink resources used for the inter-UE CLI measurement transmission 825 and/or the uplink transmission 835 to measure one or more signal quality metrics across the one or more uplink resources. The one or more signal quality metrics may include one or more of RSRP, RSSI, reference signal received quality (RSRQ), signal-to-interference-plus-noise ratio (SINR), signal-to-noise ratio (SNR), or channel quality indicator (CQI). In accordance with the one or more signal quality metrics, the victim network node 805 may measure the uplink interference level caused by the aggressor UE 815 across one or more uplink resources.

In some examples, the victim network node 805 may identify which one or more uplink resources to use for measuring the uplink interference level caused by the aggressor UE 815 in accordance with performing an uplink resource information exchange 845. For example, as part of the uplink resource information exchange 845, the neighboring network node 810 may send, via the backhaul link, and the victim network node 805 may obtain, first uplink resource information. For example, the first uplink resource information may indicate one or more uplink resources scheduled for transmission at the aggressor UE 815. In some examples, the first uplink resource information may indicate different/respective uplink resources scheduled for multiple wireless devices (e.g., CPEs and/or UEs) serviced by the neighboring network node 810. For instance, the first uplink resource information may indicate one or more first uplink resources associated with a first wireless device serviced by the neighboring network node 810 and one or more second uplink resources associated with a second wireless device serviced by the neighboring network node 810. In some examples, the first uplink resource information may indicate the type of resource associated with the one or more uplink resources (e.g., one or more of SRS-RSRP resources, CSI-RSSI resources, SRS resources, CG uplink transmission resources, etc.).

Additionally, as part of the uplink resource information exchange 845, the victim network node 805 may send, and the neighboring network node 810 may obtain via the backhaul link, second uplink resource information. In some examples, the second uplink resource information may include similar information as the first uplink resource information, but for the wireless devices serviced by the victim network node 805. For example, the second uplink resource information may indicate one or more uplink resources scheduled for transmission at the victim UE 820. In some examples, the second uplink resource information may indicate different/respective uplink resources scheduled for multiple wireless devices (e.g., CPEs and/or UEs) serviced by the victim network node 805. For instance, the second uplink resource information may indicate one or more first uplink resources associated with a first wireless device serviced by the victim network node 805 and one or more second uplink resources associated with a second wireless device serviced by the victim network node 805. In some examples, the second uplink resource information may indicate the type of resource associated with the one or more uplink resources (e.g., one or more of SRS-RSRP resources, CSI-RSSI resources, SRS resources, CG uplink transmission resources, etc.).

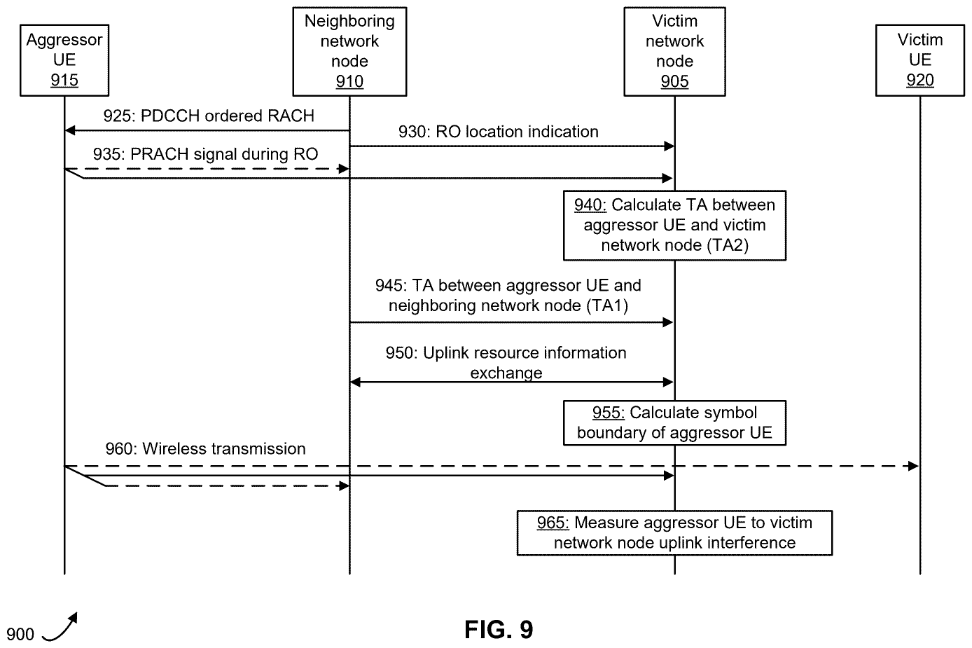

As part of, or in addition to, the uplink resource information exchange 845, the victim network node 805 may determine a timing associated with measuring an uplink resource used for a transmission by the aggressor UE 815. Descriptions of examples of determining the timing for measuring the uplink interference caused by the aggressor UE 815 are provided elsewhere herein (e.g., with reference to FIGS. 9 through 11).

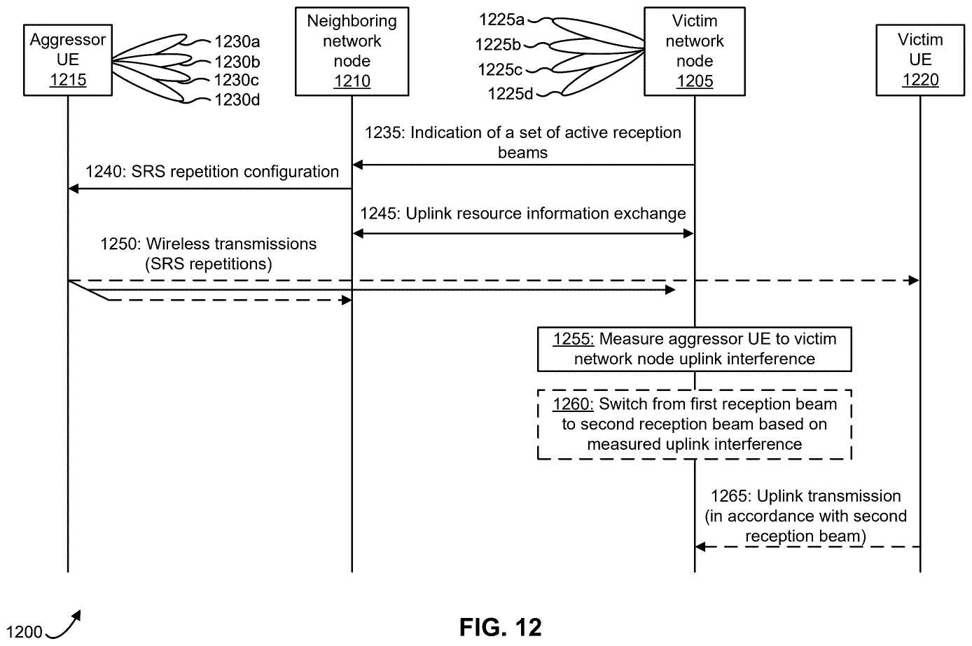

Based on the uplink resource information exchange 845, the neighboring network node 810 may configure the aggressor UE 815 with one or more SRS repetitions based on the active serving reception beams of the victim network node 805. Accordingly, the victim network node 805 may measure (e.g., in accordance with reference number 850) the one or more SRS repetitions to determine which of the active serving reception beams of the victim network node 805 may result in a lowest uplink interference caused by the aggressor UE 815. Descriptions of examples of SRS repetition configuration and active serving reception beam selection are provided elsewhere herein (e.g., with reference to FIG. 12).

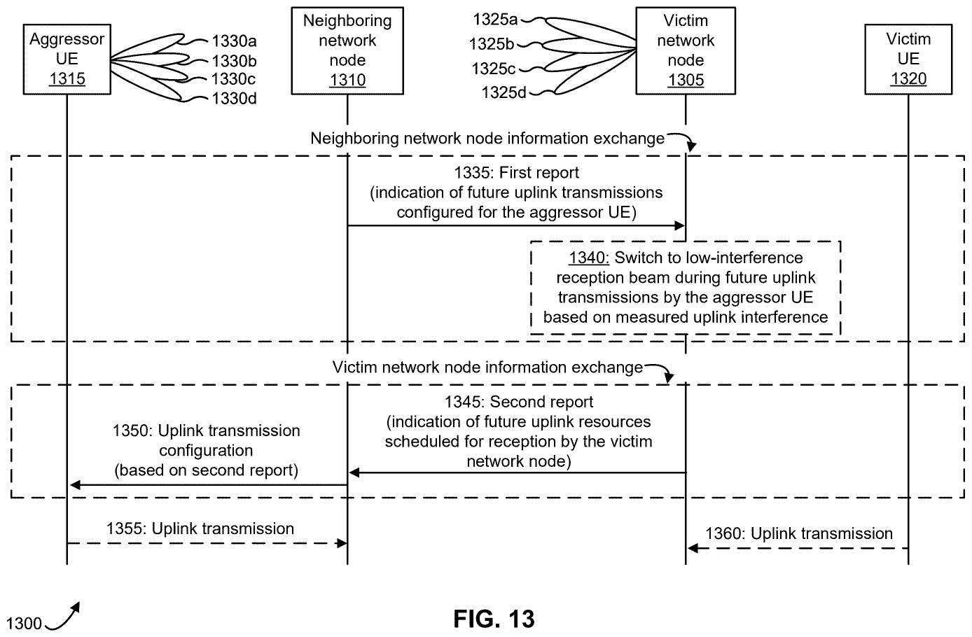

Based on measuring the uplink interference caused by the aggressor UE 815, the neighboring network node 810 may send, and the victim network node 805 may obtain, a first report that indicates one or more future uplink transmissions configured for the aggressor UE 815 such that the victim network node 805 may select an active serving reception beam associated with low interference. Additionally, or alternatively, the victim network node 805 may send, and the neighboring network node 810 may obtain, a second report indicating uplink resources that, during which, the victim network node 805 is configured to receive such that the neighboring network node 810 may avoid interference during the indicated uplink resources. Descriptions of examples of the first report and second report are provided elsewhere herein (e.g., with reference to FIG. 13).

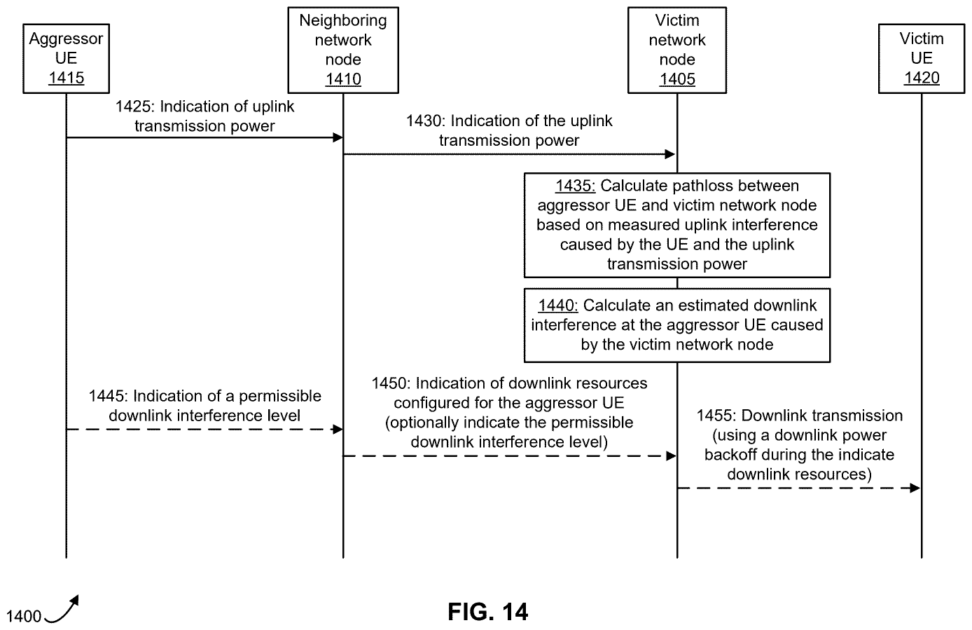

Based on measuring the uplink interference caused by the aggressor UE 815, the neighboring network node 810 may calculate a downlink interference level at the aggressor UE 815 caused by the victim network node 805 (e.g., in accordance with reference number 855). Such downlink interference may be referred to herein as “network-to-UE downlink interference” and/or “downlink interference level caused by an aggressor network node.” In accordance with calculating the network-to-UE downlink interference, the victim network node 805 may dynamically select downlink resources and/or downlink transmission beams to reduce interference experienced at the aggressor UE 815 while the victim network node 805 transmits one or more downlink transmissions. Descriptions of examples of calculating and mitigating network-to-UE downlink interference are provided elsewhere herein (e.g., with reference to FIG. 14).

FIG. 9 is a diagram illustrating an example 900 associated with a victim network node adjusting timing to measure interference caused by an aggressor UE, in accordance with the present disclosure. Example 900 may implement or be implemented by one or more aspects of FIGS. 1 through 8. For instance, example 900 includes wireless communications between a victim network node 905, a neighboring network node 910, an aggressor UE 915, and a victim UE 920, which may be respective examples of the victim network node 805, the neighboring network node 810, the aggressor UE 815, and the victim UE 820, as described with reference to FIG. 8. Alternative examples of the following may be implemented, where some operations are performed in a different order than described, or not described at all. In some cases, one or more operations may include additional features not mentioned below, or further operations may be added. In addition, while example 900 shows operations between the two UEs and two network nodes, the communications may occur between any number of network devices of various types described herein.

In a first operation 925, the neighboring network node 910 may transmit, and the aggressor UE 915 may receive, control information associated with a PDCCH ordered RACH. For example, the control information may be a DCI transmitted via a PDCCH that indicates for the aggressor UE 915 to initiate a RACH procedure. In some examples, the DCI may indicate an RACH occasion (RO) for the aggressor UE 915 to transmit a PRACH signal (e.g., random access transmission) during. For example, the DCI may indicate a preamble index and/or time/frequency resources for the aggressor UE 915 transmit the PRACH signal.

In a second operation 930, the neighboring network node 910 may send via the backhaul link, and the victim network node 905 may obtain, an RO location indication. In other words, the neighboring network node 910 may indicate the time/frequency resources of the RO indicated to the aggressor UE 915. Therefore, the victim network node 905 may monitor for the PRACH signal from the aggressor UE 915 during the RO.

In a third operation 935, the aggressor UE 915 may transmit the PRACH signal during the RO indicated by the neighboring network node 910. The victim network node 905 may intercept (e.g., receive) the PRACH signal based on monitoring for the PRACH signal during the RO. In some examples, the neighboring network node 910 may receive the PRACH signal to ensure that the PRACH signal is associated with a signal quality that satisfies a signal quality threshold. In some examples, the neighboring network node 910 may refrain from receiving the PRACH signal, in order to reduce network power expenditure.

In a fourth operation 940, the victim network node 905 may calculate a timing advance (TA) between the victim network node 905 and the aggressor UE 915 (e.g., TA2). For example, the TA may be used in wireless networks to ensure that the transmissions from a first wireless device (e.g., the aggressor UE 915) reach a second wireless device (e.g., the victim network node 905) within a correct time alignment. In a wireless communication system, a distance between the first wireless device and the second wireless device may result in a propagation delay because of the finite speed of electromagnetic waves. Therefore, when the victim network node 905 receives the PRACH signal, the victim network node 905 may calculate a difference between transmission time of the PRACH signal from the aggressor UE 915 and a reception time of the PRACH signal at the victim network node 905 (e.g., TA2).

In a fifth operation 945, the neighboring network node 910 may send via the backhaul link, and the victim network node 905 may obtain, a TA between the neighboring network node 910 and the aggressor UE 915 (e.g., TA1).

In a sixth operation 950, the neighboring network node 910 and the victim network node 905 may perform an uplink resource information exchange via the backhaul link. In some examples, the sixth operation 950 may be an example of the uplink resource information exchange 845.

In a seventh operation 955, the victim network node 905 may calculate a symbol boundary of the aggressor UE 915. For example, the victim network node 905 may calculate the symbol boundary (SB_{aggressor}) in accordance with Equation 1:

$${SB}_{aggressor} = {SB}_{victim} - \frac{( TA 2 - TA 1 )}{2} \qquad ( 1 )$$

where SB_{victim} is a serving cell boundary of the victim network node 905.

In an eighth operation 960, the aggressor UE 915 may transmit a wireless transmission. In some examples, the wireless transmission may be associated with one or more uplink resources obtained by the victim network node 905 (from the neighboring network node 910) during the uplink resource information exchange at the sixth operation 950. In some examples, the wireless transmission may be an uplink transmission scheduled for transmission to the neighboring network node 910 (e.g., the uplink transmission 835). In some examples, the wireless transmission may be an inter-UE CLI measurement transmission scheduled for transmission to the victim UE 920 or some other UE (e.g., the inter-UE CLI measurement transmission 825).

Accordingly, the victim network node 905 may intercept (e.g., receive or measure) the wireless transmission based on the wireless transmission being associated with/transmitted during one or more uplink resources obtained by the victim network node 905 during the uplink resource information exchange. In some examples, the victim network node 905 may monitor for the wireless message in accordance with SB_{aggressor}.

In a ninth operation 965, the victim network node 905 may measure the uplink interference caused by the aggressor UE 915 based on measuring the signal quality of the wireless transmission. In some examples, the ninth operation 965 may be an example of reference number 850.

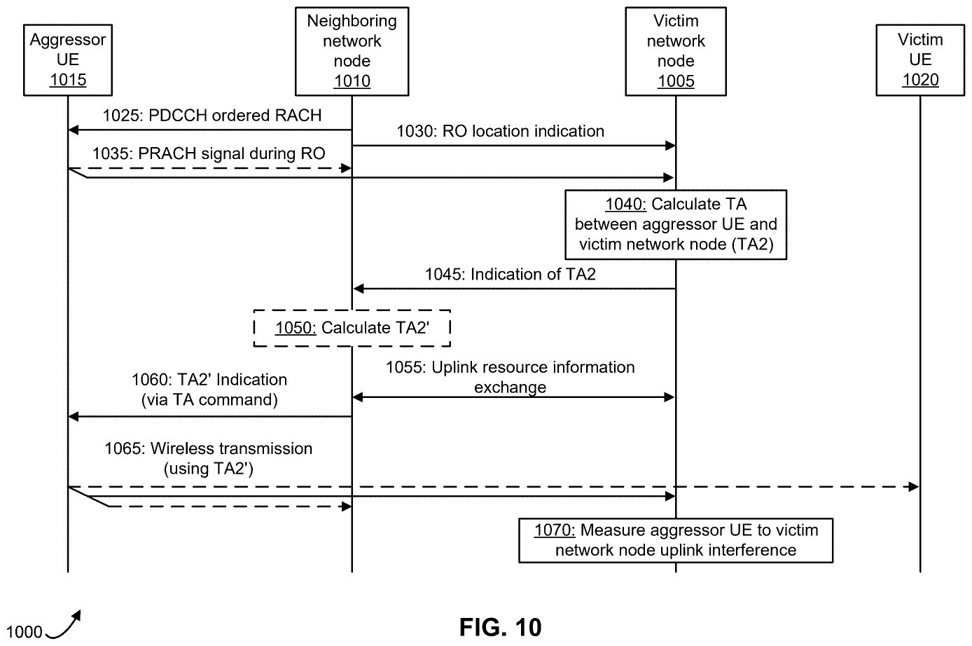

FIG. 10 is a diagram illustrating an example 1000 associated with an aggressor UE adjusting transmit timing for a victim network node to measure interference, in accordance with the present disclosure. Example 1000 may implement or be implemented by one or more aspects of FIGS. 1 through 8. For instance, example 1000 includes wireless communications between a victim network node 1005, a neighboring network node 1010, an aggressor UE 1015, and a victim UE 1020, which may be respective examples of the victim network node 805, the neighboring network node 810, the aggressor UE 815, and the victim UE 820, as described with reference to FIG. 8. Alternative examples of the following may be implemented, where some operations are performed in a different order than described, or not described at all. In some cases, one or more operations may include additional features not mentioned below, or further operations may be added. In addition, while example 1000 shows operations between the two UEs and two network nodes, the communications may occur between any number of network devices of various types described herein.

In a first operation 1025, the neighboring network node 1010 may transmit, and the aggressor UE 1015 may receive, control information associated with a PDCCH ordered RACH. For example, the control information may be a DCI transmitted via a PDCCH that indicates for the aggressor UE 1015 to initiate a RACH procedure. In some examples, the DCI may indicate an RO for the aggressor UE 1015 to transmit a PRACH signal (e.g., random access transmission) during. For example, the DCI may indicate a preamble index and/or time/frequency resources for the aggressor UE 1015 transmit the PRACH signal.

In a second operation 1030, the neighboring network node 1010 may send via the backhaul link, and the victim network node 1005 may obtain, an RO location indication. In other words, the neighboring network node 1010 may indicate the time/frequency resources of the RO indicated to the aggressor UE 1015. Therefore, the victim network node 1005 may monitor for the PRACH signal from the aggressor UE 1015 during the RO.

In a third operation 1035, the aggressor UE 1015 may transmit the PRACH signal during the RO indicated by the neighboring network node 1010. The victim network node 1005 may intercept (e.g., receive) the PRACH signal based on monitoring for the PRACH signal during the RO. In some examples, the neighboring network node 1010 may receive the PRACH signal to ensure that the PRACH signal is associated with a signal quality that satisfies a signal quality threshold. In some examples, the neighboring network node 1010 may refrain from receiving the PRACH signal, in order to reduce network power expenditure.

In a fourth operation 1040, the victim network node 1005 may calculate a TA between the victim network node 1005 and the aggressor UE 1015 (e.g., TA2). For example, the TA may be used in wireless networks to ensure that the transmissions from a first wireless device (e.g., the aggressor UE 1015) reach a second wireless device (e.g., the victim network node 1005) within the correct time alignment. In a wireless communication system, a distance between the first wireless device and the second wireless device may result in a propagation delay because of the finite speed of electromagnetic waves. Therefore, when the victim network node 1005 receives the PRACH signal, the victim network node 1005 may calculate a difference between transmission time of the PRACH signal from the aggressor UE 1015 and a reception time of the PRACH signal at the victim network node 1005 (e.g., TA2).

In a fifth operation 1045, the victim network node 1005 may send via the backhaul link, and the neighboring network node 1010 may obtain, an indication of the TA between the victim network node 1005 and the aggressor UE 1015 (e.g., TA2).

In a sixth operation 1050, the neighboring network node 1010 may optionally calculate a TA for the aggressor UE 1015 to operate in accordance with (e.g., TA2′) that is based on TA2 and a TA between the neighboring network node 1010 and the aggressor UE 1015 (e.g., TA1). For example, the neighboring network node 1010 may calculate TA2′ in accordance with Equation 2:

$$TA {2}^{′} = TA 2 - \frac{( TA 1 - TA 2 )}{2} \qquad ( 2 )$$

In a seventh operation 1055, the neighboring network node 1010 and the victim network node 1005 may perform an uplink resource information exchange via the backhaul link. In some examples, the seventh operation 1055 may be an example of the uplink resource information exchange 845.

In an eighth operation 1060, the neighboring network node 1010 may transmit, and the aggressor UE 1015 may receive, an indication of TA2′. For example, the indication of TA2′ may be included in a TA command (e.g., transmitted via MAC-CE or DCI). In some examples, the TA command may explicitly indicate the value of TA2′. In some examples, the TA command may indicate TA2. In such examples, the aggressor UE 1015 may calculate TA2′ using the received indication of TA2, in accordance with Equation 2. In some examples, the TA command may indicate how the aggressor UE 1015 may calculate TA2′ (e.g., indicate Equation 2). In some examples, Equation 2 may be defined in a wireless communications standard, such as 3GPP.

In some examples, the aggressor UE 1015 may be implicitly configured to transmit in accordance with TA2′ for SRS transmission. For example, the aggressor UE 1015 may operate in accordance with a rule defined in a wireless communications standard (e.g., 3GPP) that indicates to transmit SRS transmissions in accordance with TA2′.

In some examples, the TA command may include one or more bits respectively indicating whether to apply TA2′ to one or more SRS transmissions. For instance, if a bit from the one or more bits is a first value, then the aggressor UE 1015 should apply TA2′ for the associated SRS transmission, and if the bit is a second value, then the aggressor UE 1015 should not apply TA2′ for the associated SRS transmission. In some examples, the one or more bits may be respectively associated with different types of SRS transmissions. For example, a first bit of the one or more bits may be associated with whether to apply TA2′ to periodic SRS transmissions, a second bit of the one or more bits may be associated with whether to apply TA2′ to semi-persistent SRS transmissions, and/or a third bit of the one or more bits may be associated with whether to apply TA2′ to aperiodic SRS transmissions.

In some examples, the TA command may indicate for the aggressor UE 1015 to define TA2′ for SRS transmissions in accordance with Equation 2. In some examples, the aggressor UE 1015 may assume that the TA offset is the same between the neighboring network node 1010 and the victim network node 1005 (e.g., TA2 is equal to TA1). In other words, Equation 2 may be simplified such that TA2′=TA2 or TA2′=TA1.

In a ninth operation 1065, the aggressor UE 1015 may transmit a wireless transmission in accordance with applying TA2′. In some examples, the wireless transmission may be associated with one or more uplink resources obtained by the victim network node 1005 (from the neighboring network node 1010) during the uplink resource information exchange at the seventh operation 1055. In some examples, the wireless transmission may be an uplink transmission scheduled for transmission to the neighboring network node 1010 (e.g., the uplink transmission 835). In some examples, the wireless transmission may be an inter-UE CLI measurement transmission scheduled for transmission to the victim UE 1020 or some other UE (e.g., the inter-UE CLI measurement transmission 825).

Accordingly, the victim network node 1005 may intercept (e.g., receive or measure) the wireless transmission based on the wireless transmission being associated with/transmitted during one or more uplink resources obtained by victim network node 1005 during the uplink resource information exchange. In some examples, the victim network node 1005 may operate in accordance with TA2 for receiving the wireless transmission from the aggressor UE 1015. In some examples, the neighboring network node 1010 and/or the victim network node 1005 may configure one or more gap symbols before the wireless transmission in order to avoid uplink interference caused by other uplink transmissions.

In a tenth operation 1070, the victim network node 1005 may measure the uplink interference caused by the aggressor UE 1015 based on measuring the signal quality of the wireless transmission. In some examples, the tenth operation 1070 may be an example of reference number 850.

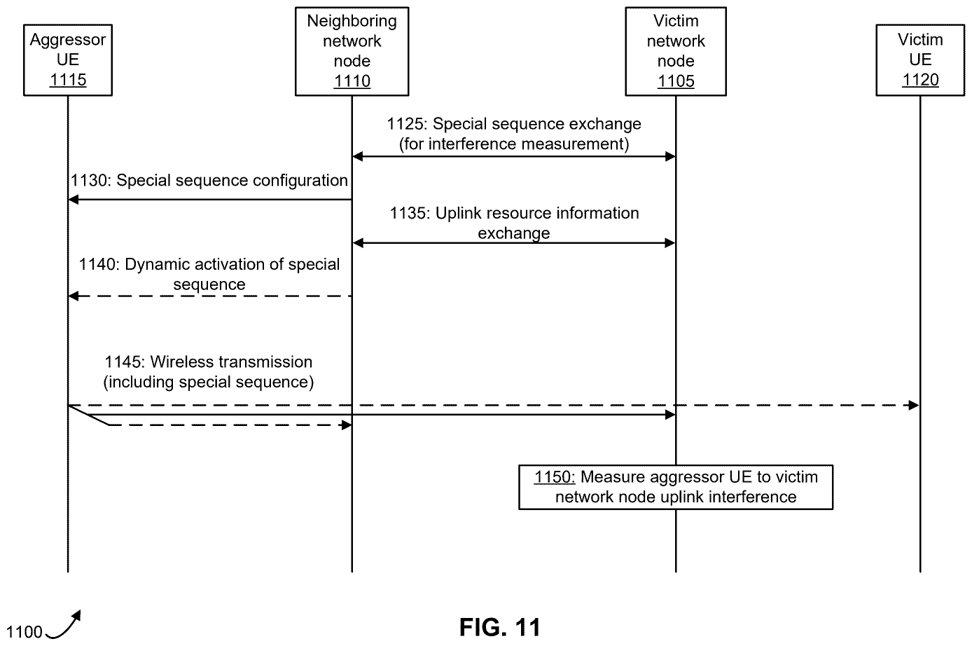

FIG. 11 is a diagram illustrating an example 1100 associated with a special sequence exchange used in accordance with measuring interference caused by an aggressor UE, in accordance with the present disclosure. Example 1100 may implement or be implemented by one or more aspects of FIGS. 1 through 8. For instance, example 1100 includes wireless communications between a victim network node 1105, a neighboring network node 1110, an aggressor UE 1115, and a victim UE 1120, which may be respective examples of the victim network node 805, the neighboring network node 810, the aggressor UE 815, and the victim UE 820, as described with reference to FIG. 8. Alternative examples of the following may be implemented, where some operations are performed in a different order than described, or not described at all. In some cases, one or more operations may include additional features not mentioned below, or further operations may be added. In addition, while example 1100 shows operations between the two UEs and two network nodes, the communications may occur between any number of network devices of various types described herein.

In a first operation 1125, the neighboring network node 1110 and the victim network node 1105 may perform a special sequence exchange via the backhaul link. For example, as part of the special sequence exchange, the neighboring network node 1110 and the victim network node 1105 may determine and/or select a special sequence for the aggressor UE 1115 to prepend to one or more wireless transmissions. In some examples, the special sequence may be associated with a format length that satisfies and/or is above a length threshold (e.g., a long format length). For example, the special sequence may be a cyclic prefix. In some examples, a cyclic prefix is a portion of the end of an OFDM symbol that may be copied and prepended to the beginning of the OFDM symbol to mitigate issues caused by multipath propagation, such as inter-symbol interference (ISI) and inter-carrier interference (ICI). In some examples, the neighboring network node 1110 and the victim network node 1105 may select the special sequence from a contention-free random access (CFRA) preamble pool.

In a second operation 1130, the neighboring network node 1110 may transmit, and the aggressor UE 1115 may receive, a special sequence configuration that indicates the special sequence selected by the neighboring network node 1110 and the victim network node 1105. In some examples, the special sequence configuration may indicate an index associated with the CFRA preamble pool that points to the special sequence. In some examples, the neighboring network node 1110 may transmit the special sequence configuration via control signaling (e.g., via RRC signaling, MAC signaling, and/or DCI signaling).

In a third operation 1135, the neighboring network node 1110 and the victim network node 1105 may perform an uplink resource information exchange via the backhaul link. In some examples, the third operation 1135 may be an example of the uplink resource information exchange 845.

In a fourth operation 1140, the neighboring network node 1110 may optionally transmit, and the aggressor UE 1115 may receive, a dynamic activation of the special sequence. For example, the dynamic activation may indicate one or more wireless transmissions configured for transmission by the aggressor UE 1115 that the aggressor UE 1115 should transmit in accordance with the special sequence. In some examples, the one or more wireless transmissions indicated in the dynamic activation may be associated with one or more uplink resources that the neighboring network node 1110 sends to the victim network node 1105 as part of the uplink resource information exchange. In some examples, the dynamic activation may indicate one or more types of wireless transmissions that the aggressor UE 1115 should transmit in accordance with the special sequence (e.g., SRS transmissions or inter-UE CLI measurement transmissions, among other examples). In some examples, the dynamic activation may be transmitted via MAC-CE or DCI.

In a fifth operation 1145, the aggressor UE 1115 may transmit a wireless transmission in accordance with a special sequence (e.g., includes the special sequence at the beginning of the wireless transmission). In some examples, the wireless transmission may be associated with one or more uplink resources obtained by the victim network node 1105 (from the neighboring network node 1110) during the uplink resource information exchange at the third operation 1135. In some examples, the wireless transmission may be an uplink transmission scheduled for transmission to the neighboring network node 1110 (e.g., the uplink transmission 835). In some examples, the wireless transmission may be an inter-UE CLI measurement transmission scheduled for transmission to the victim UE 1120 or some other UE (e.g., the inter-UE CLI measurement transmission 825).

Accordingly, the victim network node 1105 may intercept (e.g., receive or measure) the wireless transmission based on the wireless transmission being associated with/transmitted during one or more uplink resources obtained by victim network node 1105 during the uplink resource information exchange. In some examples, the length of the special sequence may be enough to account for a difference in a TA between the aggressor UE 1115 and the victim network node 1105 (e.g., TA2) and a TA between the aggressor UE 1115 and the neighboring network node 1110 (e.g., TA1).

In a sixth operation 1150, the victim network node 1105 may measure the uplink interference caused by the aggressor UE 1115 based on measuring the signal quality of the wireless transmission. In some examples, the sixth operation 1150 may be an example of reference number 850.

FIG. 12 is a diagram illustrating an example 1200 associated with a reference signal configuration used in accordance with measuring interference caused by an aggressor UE, in accordance with the present disclosure. Example 1200 may implement or be implemented by one or more aspects of FIGS. 1 through 11. For instance, example 1200 includes wireless communications between a victim network node 1205, a neighboring network node 1210, an aggressor UE 1215, and a victim UE 1220, which may be respective examples of the victim network node 805, the neighboring network node 810, the aggressor UE 815, and the victim UE 820, as described with reference to FIG. 8. Alternative examples of the following may be implemented, where some operations are performed in a different order than described, or not described at all. In some cases, one or more operations may include additional features not mentioned below, or further operations may be added. In addition, while example 1200 shows operations between the two UEs and two network nodes, the communications may occur between any number of network devices of various types described herein.

In a first operation 1235, the neighboring network node 1210 may send via the backhaul link, and the victim network node 1205 may obtain, an indication of a set of active reception beams 1225 (or a total number of narrow beams) associated with the neighboring network node 1210 (e.g., a reception beam 1225a, 1225b, 1225c, and 1225d). For example, the set of active reception beams 1225 may be a set of beams that the neighboring network node 1210 may use to receive one or more uplink transmissions from one or more wireless devices (e.g., the victim UE 1220) serviced by the neighboring network node 1210.

In a second operation 1240, the victim network node 1205 may transmit, and the aggressor UE 1215 may receive, an SRS repetition configuration. For example, the SRS repetition configuration may indicate a set of SRS repetitions for the aggressor UE 1215 to periodically transmit. In some examples, the set of SRS repetitions may be respectively associated with a set of transmission beams 1230 associated with the aggressor UE 1215 (e.g., reception beams 1230a, 1230b, 1230c, and 1230d). In some examples, the set of SRS repetitions may be associated with one or more uplink transmissions to the victim network node 1205 (e.g., one or more uplink transmissions 835). In some examples, the set of SRS repetitions may be associated with one or more inter-UE CLI measurement transmissions (e.g., one or more inter-UR CLI measurement transmissions 825). In some examples, the victim network node 1205 may transmit the SRS repetition configuration via one or more of RRC signaling, MAC signaling, or DCI signaling.

In a fourth operation 1250, the aggressor UE 1215 may transmit one or more wireless transmissions in accordance with an SRS repetition configuration. For example, the aggressor UE 1215 may transmit the set of SRS repetitions via the set of transmission beams 1230. In some examples, the wireless transmissions may be associated with one or more uplink resources obtained by the victim network node 1205 (from the neighboring network node 1210) during the uplink resource information exchange at the third operation 1245. In some examples, the set of SRS repetitions may be scheduled for transmission to the neighboring network node 1210 (e.g., a set of uplink transmissions 835). In some examples, the set of SRS repetitions may be associated with an inter-UE CLI measurement transmission scheduled for transmission to the victim UE 1220 or some other UE (e.g., the inter-UE CLI measurement transmission 825).

Accordingly, the victim network node 1205 may intercept (e.g., receive or measure) the wireless transmission based on the wireless transmission being associated with/transmitted during one or more uplink resources obtained by victim network node 1205 during the uplink resource information exchange.

In a fifth operation 1255, the victim network node 1205 may measure the uplink interference across the set of reception beams 1225 caused by the aggressor UE 1215 based on measuring the signal quality of the set of SRS repetitions. In some examples, the fifth operation 1255 may be an example of reference number 850.

In a sixth operation 1260, the neighboring network node 1210 may optionally switch reception beams 1225 based on the measured uplink interference caused by the aggressor UE 1215. For example, the neighboring network node 1210 may measure the uplink interference at reception beam 1225a to be higher than the uplink interference at reception beam 1225b. Therefore, the neighboring network node 1210 may switch from using reception beam 1225a to using reception beam 1225b for receiving uplink transmissions.

In a seventh operation 1265, the victim UE 1220 may optionally transmit, and the neighboring network node 1210 may receive, an uplink transmission. For example, the neighboring network node 1210 may receive the uplink transmission using the reception beam 1225b to reduce uplink interference caused by the aggressor UE 1215.

FIG. 13 is a diagram illustrating an example 1300 associated with a network node information exchange for mitigation of uplink interference caused by an aggressor UE, in accordance with the present disclosure. Example 1300 may implement or be implemented by one or more aspects of FIGS. 1 through 12. For instance, example 1300 includes wireless communications between a victim network node 1305, a neighboring network node 1310, an aggressor UE 1315, and a victim UE 1320, which may be respective examples of the victim network node 805, the neighboring network node 810, the aggressor UE 815, and the victim UE 820, as described with reference to FIG. 8. Additionally, a set of reception beams 1325 (e.g., a reception beam 1325a, 1325b, 1325c, and 1325d) may be an example of the set of reception beams 1225, as described with reference to FIG. 12. Additionally, a set of transmission beams 1330 (e.g., a transmission beam 1330a, 1330b, 1330c, and 1330d) may be an example of the set of transmission beams 1230, as described with reference to FIG. 12. Alternative examples of the following may be implemented, where some operations are performed in a different order than described, or not described at all. In some cases, one or more operations may include additional features not mentioned below, or further operations may be added. In addition, while example 1300 shows operations between the two UEs and two network nodes, the communications may occur between any number of network devices of various types described herein.

In some examples, one or more operations of example 1300 may be performed after the victim network node 1305 measures the uplink interference caused by the aggressor UE 1315, as described elsewhere herein (e.g., including FIGS. 8 through 12). Based on measuring the interference caused by the aggressor UE 1315, the neighboring network node 1310 and the victim network node 1305 may perform one or more information exchanges.

In some examples, the neighboring network node 1310 and victim network node 1305 may perform a neighboring network node information exchange.

In a first operation 1335, the neighboring network node 1310 may send via the backhaul link, and the victim network node 1305 may obtain, a first report in accordance with the neighboring network node information exchange. For example, the first report may indicate one or more future uplink transmissions and/or one or more uplink resources configured for the aggressor UE 1315.

In a second operation 1340, the neighboring network node 1310 may optionally switch to a low-interference reception beam 1325 in accordance with the first report and based on measuring the uplink interference caused by the aggressor UE 1315. For example, the victim network node 1305 may be initially using the reception beam 1325a to receive one or more uplink transmissions; however, the reception beam 1325a may be associated with a higher level of uplink interference caused by the aggressor UE 1315, as compared to the reception beam 1325b. Therefore, the victim network node 1305 may switch to the reception beam 1325b during at least the one or more future uplink transmissions and/or one or more uplink resources indicated in the first report.

In addition, or alternatively, to the neighboring network node information exchange, the neighboring network node 1310 and victim network node 1305 may perform a victim network node information exchange.

In a third operation 1345, the victim network node 1305 may send via the backhaul link, and the neighboring network node 1310 may obtain, a second report in accordance with the victim network node information exchange. For example, the second report may indicate one or more uplink resources and/or one or more uplink transmissions configured for reception at the victim network node 1305.

In some examples, the second report may include one or more requests. For example, the victim network node 1305 may request for the neighboring network node 1310 to avoid scheduling the aggressor UE 1315 on the one or more uplink resources indicated in the second report. Additionally, or alternatively, the victim network node 1305 may request for the aggressor UE 1315 to avoid using one or more transmission beams 1330 during the one or more uplink resources indicated in the second report. For instance, while measuring the uplink interference caused by the aggressor UE 1315, the victim network node 1305 may measure one or more reference signals (e.g., one or more SRSs, one or more DMRSs, and/or one or more PTRSs, among other examples) respectively transmitted by the aggressor UE 1315 using one or more transmission beams 1330. Therefore, the victim network node 1305 may indicate which of the one or more measured reference signals are associated with an uplink interference that satisfies or is above an interference threshold. Additionally, or alternatively, the victim network node 1305 may request the aggressor UE 1315 to backoff and/or reduce a transmission power during the one or more uplink resources indicated in the second report. For example, the victim network node 1305 may indicate a number of N dB by which the aggressor UE 1315 should reduce an associated transmission power during the one or more uplink resources indicated in the second report.

In a fourth operation 1350, the neighboring network node 1310 may transmit, and the aggressor UE 1315 may receive, an uplink transmission configuration based on the second report. For example, the uplink transmission configuration may avoid scheduling the aggressor UE 1315 on the one or more uplink resources indicated in the second report. Additionally, or alternatively, the uplink transmission configuration may indicate one or more transmission beams 1330 that the aggressor UE 1315 should avoid using during the one or more uplink resources indicated in the second report. Additionally, or alternatively, the uplink transmission configuration may request the aggressor UE 1315 to backoff and/or reduce a transmission power during the one or more uplink resources indicated in the second report. For example, the uplink transmission configuration may indicate the number of N dB as indicated in the second report. In some examples, the uplink transmission configuration may be signaled via one or more of RRC signaling, MAC signaling, or DCI signaling.

In a fifth operation 1355, the aggressor UE 1315 may optionally transmit, and the neighboring network node 1310 may receive, an uplink transmission. In some examples, the aggressor UE 1315 may transmit the uplink transmission in accordance with the uplink transmission configuration.

In a sixth operation 1360, the victim UE 1320 may optionally transmit, and the victim network node 1305 may receive, an uplink transmission. In some examples, the victim network node 1305 may receive the uplink transmission in accordance with the first report. For example, if the uplink transmission is scheduled during one or more uplink resources indicated in the first report, then the victim network node 1305 may receive the uplink transmission using the reception beam 1325b in order to reduce uplink interference caused by the aggressor UE 1315.

FIG. 14 is a diagram illustrating an example 1400 associated with estimating downlink interference at an aggressor UE caused by a victim network node, in accordance with the present disclosure. Example 1400 may implement or be implemented by one or more aspects of FIGS. 1 through 13. For instance, example 1400 includes wireless communications between a victim network node 1405, a neighboring network node 1410, an aggressor UE 1415, and a victim UE 1420, which may be respective examples of the victim network node 805, the neighboring network node 810, the aggressor UE 815, and the victim UE 820, as described with reference to FIG. 8. Alternative examples of the following may be implemented, where some operations are performed in a different order than described, or not described at all. In some cases, one or more operations may include additional features not mentioned below, or further operations may be added. In addition, while example 1400 shows operations between the two UEs and two network nodes, the communications may occur between any number of network devices of various types described herein.

In some examples, one or more operations of example 1400 may be performed after the victim network node 1405 measures the uplink interference caused by the aggressor UE 1415, as described elsewhere herein (e.g., including FIGS. 8 through 12). Based on measuring the interference caused by the aggressor UE 1415, the victim network node 1405 may estimate a downlink interference level at the aggressor UE 1415 caused by the victim network node 1405.

In a first operation 1425, the aggressor UE 1415 may transmit, and the neighboring network node 1410 may receive, an indication of an uplink transmission power. For example, the uplink transmission power may be the power level at which the aggressor UE 1415 transmitted one or more uplink transmissions measured by the victim network node 1405 to calculate the uplink interference at the victim network node 1405 caused by the aggressor UE 1415. In some examples, the indication of an uplink transmission power may be a number of M dBm. In some examples, the aggressor UE 1415 may transmit the indication of an uplink transmission power via one or more of RRC signaling, MAC signaling, or UCI signaling. In some examples, the aggressor UE 1415 may transmit the indication of the uplink transmission power based on receiving, from the neighboring network node 1410 (e.g., via RRC signaling, MAC signaling, or DCI signaling), a request to transmit the uplink transmission power.

In second operation 1430, the neighboring network node 1410 may send, and the victim network node 1405 may obtain, the indication of the uplink transmission power.

In a third operation 1435, the victim network node 1405 may calculate a value for a pathloss between the aggressor UE 1415 and victim network node 1405. For example, the victim network node 1405 may calculate the value of the pathloss based on the measured uplink interference caused by the aggressor UE 1415 and the uplink transmission power indicated by the aggressor UE 1415.

In a fourth operation 1440, the victim network node 1405 may calculate an estimated downlink interference at the aggressor UE 1415 caused by the victim network node 1405. For example, based on a current downlink transmission power of the victim network node 1405 and the value of the pathloss, the victim network node 1405 may calculate the estimated downlink interference at the aggressor UE 1415 caused by the victim network node 1405. In some examples, the third operation 1435 and/or the fourth operation 1440 may be an example of reference number 855.

In a fifth operation 1445, the aggressor UE 1415 may optionally transmit, and the neighboring network node 1410 may receive, an indication of a permissible (e.g., maximum) downlink interference level of the aggressor UE 1415 (e.g., a value P dB above a base noise level). In some examples, the aggressor UE 1415 may transmit the indication of the permissible downlink interference level and the indication of the uplink transmission power via a same transmission. In some examples, the aggressor UE 1415 may transmit the indication of the permissible downlink interference level in separate signaling from the indication of the uplink transmission power (e.g., via separate RRC signaling, MAC signaling, or UCI signaling).

In a sixth operation 1450, the neighboring network node 1410 may optionally send, and the victim network node 1405 may obtain, an indication of one or more downlink resources configured for the aggressor UE 1415. In other words, the neighboring network node 1410 may indicate one or more durations where the aggressor UE 1415 may be receiving one or more downlink transmissions. In some examples, the sixth operation may optionally indicate the permissible downlink interference level of the aggressor UE 1415 (e.g., the value of P dB).

In a seventh operation 1455, the victim network node 1405 may optionally transmit, and the victim UE 1420 may receive, a downlink transmission. In some examples, the victim network node 1405 may transmit the downlink transmission in accordance with a downlink power backoff during the one or more indicate downlink resources configured for the aggressor UE 1415. In other words, the victim network node 1405 may reduce a transmission power in order to reduce downlink interference at the aggressor UE 1415 caused by the victim network node 1405. In some examples, the victim network node 1405 may reduce the transmission power such that the resulting downlink interference at the aggressor UE 1415 satisfies or is less than the permissible downlink interference level indicated by the aggressor UE 1415.

FIG. 15 is a diagram illustrating an example process 1500 performed, for example, at a victim network node or an apparatus of a victim network node, in accordance with the present disclosure. Example process 1500 is an example where the apparatus or the victim network node (e.g., victim network node 110) performs operations associated with interference handling for neighboring wireless devices.

As shown in FIG. 15, in some aspects, process 1500 may include obtaining, from a neighboring network node, an indication of uplink resource information associated with an aggressor UE serviced by the neighboring network node (block 1510). For example, the victim network node (e.g., using reception component 1802 and/or communication manager 1806, depicted in FIG. 18) may obtain, from a neighboring network node, an indication of uplink resource information associated with an aggressor UE serviced by the neighboring network node, as described above.

As further shown in FIG. 15, in some aspects, process 1500 may include measuring an uplink interference level caused by the aggressor UE in accordance with the uplink resource information (block 1520). For example, the victim network node (e.g., using communication manager 1806, depicted in FIG. 18) may measure an uplink interference level caused by the aggressor UE in accordance with the uplink resource information, as described above.

Process 1500 may include additional aspects, such as any single aspect or any combination of aspects described below and/or in connection with one or more other processes described elsewhere herein.

In a first aspect, the uplink resource information includes one or more of CLI measurement resources for one or more inter-UE CLI measurement transmissions from the aggressor UE, SRS resources for one or more SRS transmissions from the aggressor UE, CG resources for one or more CG uplink transmissions from the aggressor UE, uplink resources for an uplink data channel transmission from the aggressor UE, or uplink resources for an uplink reference signal transmission from the aggressor UE.

In a second aspect, process 1500 includes obtaining, from the neighboring network node, an indication of a RO associated with the aggressor UE, receiving, from the aggressor UE during the RO, a PRACH signal, where a first TA between the aggressor UE and the victim network node is calculated in accordance with reception of the PRACH signal, obtaining, from the neighboring network node, an indication of a second TA between the aggressor UE and the neighboring network node, and measuring the uplink interference level caused by the aggressor UE in accordance with a symbol boundary of the aggressor UE, where the symbol boundary is calculated in accordance with a serving cell boundary of the victim network node, the first TA, and the second TA.

In a third aspect, process 1500 includes obtaining, from the neighboring network node, an indication of a RO associated with the aggressor UE, receiving, from the aggressor UE during the RO, a PRACH signal, where a first TA between the aggressor UE and the victim network node is calculated in accordance with reception of the PRACH signal, outputting, to the neighboring network node, an indication of the first TA, and measuring an uplink interference level caused by the aggressor UE in accordance with the first TA.

In a fourth aspect, process 1500 includes communicating, with the neighboring network node, an indication of a sequence to prepend to one or more uplink transmissions, where the sequence is associated with a length that satisfies a length threshold, and receiving, from the aggressor UE, an uplink transmission that includes the sequence, where measuring the uplink interference level caused by the aggressor UE is based at least in part on receiving the uplink transmission.

In a fifth aspect, the indication of the sequence comprises a value that points to an index of a CFRA preamble pool that indicates the sequence.

In a sixth aspect, process 1500 includes outputting, to the neighboring network node, an indication of a set of active serving reception beams at the victim network node, where measuring the uplink interference level caused by the aggressor UE is based at least in part on measuring a set of SRS repetitions respectively associated with a set of transmission beams at the aggressor UE.

In a seventh aspect, process 1500 includes switching from a first reception beam of the set of active reception beams to a second reception beam of the set of active reception beams based at least in part on measuring a set of interference levels respectively associated with the set of SRS repetitions.

In an eighth aspect, process 1500 includes receiving, from a UE serviced by the victim network node, an uplink transmission via an uplink reception beam, where the uplink reception beam is selected in accordance with the uplink interference level caused by the aggressor UE.

In a ninth aspect, process 1500 includes outputting, to the neighboring network node, an uplink resource configuration request for the aggressor UE based at least in part on the uplink interference level caused by the aggressor UE.

In a tenth aspect, the uplink resource configuration request indicates one or more of a first request for the neighboring network node to avoid scheduling the aggressor UE during one or more uplink resources, a second request for the aggressor UE to avoid using one or more associated uplink transmission beams during one or more uplink resources, or a third request for the aggressor UE to reduce an associated output power by a power reduction value.

In an eleventh aspect, process 1500 includes obtaining, from the neighboring network node, an indication of an uplink transmission power of the aggressor UE during measurement of the uplink interference level caused by the aggressor UE, determining a pathloss between the aggressor UE and the victim network node based at least in part on the uplink interference level at the victim network node caused by the aggressor UE and the uplink transmission power, and determining an estimated downlink interference level at the aggressor UE caused by the victim network node based at least in part on a downlink transmission power of the victim network node and the pathloss.

In a twelfth aspect, process 1500 includes obtaining, from the neighboring network node, an indication of a set of downlink resources configured for downlink transmissions from the neighboring network node to the aggressor UE, and performing, in accordance with the estimated downlink interference level, a downlink transmission power backoff during one or more downlink resources of the set of downlink resources.

In a thirteenth aspect, process 1500 includes obtaining, from the neighboring network node, an indication of an interference tolerance level associated with the aggressor UE, where the downlink transmission power backoff satisfies the interference tolerance level.

In a fourteenth aspect, the aggressor UE is a CPE.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a neighboring network node or an apparatus of a neighboring network node, in accordance with the present disclosure. Example process 1600 is an example where the apparatus or the neighboring network node (e.g., neighboring network node 110) performs operations associated with interference handling for neighboring wireless devices.

As shown in FIG. 16, in some aspects, process 1600 may include outputting, to a victim network node, an indication of uplink resource information associated with an aggressor UE serviced by the neighboring network node, where the uplink resource information is associated measurement of an uplink interference level caused by the aggressor UE at the victim network node (block 1610). For example, the neighboring network node (e.g., using transmission component 1804 and/or communication manager 1806, depicted in FIG. 18) may output, to a victim network node, an indication of uplink resource information associated with an aggressor UE serviced by the neighboring network node, where the uplink resource information is associated measurement of an uplink interference level caused by the aggressor UE at the victim network node, as described above.

Process 1600 may include additional aspects, such as any single aspect or any combination of aspects described below and/or in connection with one or more other processes described elsewhere herein.

In a first aspect, the uplink resource information includes one or more of CLI measurement resources for one or more inter-UE CLI measurement transmissions from the aggressor UE, SRS resources for one or more SRS transmissions from the aggressor UE, CG resources for one or more CG uplink transmissions from the aggressor UE, uplink resources for an uplink data channel transmission from the aggressor UE, or uplink resources for an uplink reference signal transmission from the aggressor UE.

In a second aspect, process 1600 includes transmitting, to the aggressor UE, a PDCCH ordered RACH configuration that indicates for the aggressor UE to transmit a PRACH signal during a RO, outputting, to the victim network node, an indication of the RO, and outputting, to the victim network node, an indication of a TA between the aggressor UE and the neighboring network node.

In a third aspect, process 1600 includes transmitting, to the aggressor UE, a PDCCH ordered RACH configuration that indicates for the aggressor UE to transmit a PRACH signal during a RO, outputting, to the victim network node, an indication of the RO, and obtaining, from the victim network node, an indication of the of a first TA between the aggressor UE and the victim network node in accordance with the PRACH signal, and transmitting, to the aggressor UE, a TA command that indicates whether to use a second TA to use for one or more SRS transmissions, where the second TA is based at least in part on the first TA and a third TA between the aggressor UE and the neighboring network node.

In a fourth aspect, the TA command includes one or more bits respectively associated with the one or more SRS transmissions, and the one or more bits respectively indicate whether to use the second TA for an associated SRS transmission.

In a fifth aspect, process 1600 includes communicating, with the victim network node, a first indication of a sequence to prepend to one or more uplink transmissions, where the sequence is associated with a length that satisfies a length threshold, and transmitting, to the aggressor UE, a second indication of the sequence for the aggressor UE to prepend to one or more uplink transmissions.

In a sixth aspect, the second indication of the sequence comprises a value that points to an index of a CFRA preamble pool that indicates the sequence.

In a seventh aspect, process 1600 includes obtaining, from the victim network node, an indication of a set of active serving reception beams at the victim network node.

In an eighth aspect, process 1600 includes transmitting, to the aggressor UE, control information that schedules a set of SRS repetitions in accordance with the set of active serving reception beams at the victim network node.

In a ninth aspect, process 1600 includes obtaining, from the victim network node, an uplink resource configuration request for the aggressor UE based at least in part on the uplink resource information.

In a tenth aspect, the uplink resource configuration request indicates one or more of a first request for the neighboring network node to avoid scheduling the aggressor UE during one or more uplink resources, a second request for the aggressor UE to avoid using one or more associated uplink transmission beams during the one or more uplink resources, or a third request for the aggressor UE to reduce an associated output power by a power reduction value.

In an eleventh aspect, process 1600 includes receiving, from the aggressor UE, an indication of an uplink transmission power associated with an uplink transmission, and outputting, to the victim network node, the indication of the uplink transmission power.

In a twelfth aspect, process 1600 includes outputting, to the victim network node, an indication of a set of downlink resources configured for downlink transmissions to the aggressor UE.

In a thirteenth aspect, process 1600 includes receiving, from the aggressor UE, an indication of an interference tolerance level associated with the aggressor UE, and outputting, to the victim network node, the indication of the interference tolerance level associated with the aggressor UE.

In a fourteenth aspect, the aggressor UE is a CPE.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a UE or an apparatus of a UE, in accordance with the present disclosure. Example process 1700 is an example where the apparatus or the UE (e.g., UE 120 or aggressor UE) performs operations associated with interference handling for neighboring wireless devices.

As shown in FIG. 17, in some aspects, process 1700 may include transmitting an uplink transmission associated with determination of an uplink interference level caused by the aggressor UE at a victim network node, where the aggressor UE is serviced by a neighboring network node that neighbors the victim network node (block 1710). For example, the UE (e.g., using transmission component 1904 and/or communication manager 1906, depicted in FIG. 19) may transmit an uplink transmission associated with determination of an uplink interference level caused by the aggressor UE at a victim network node, where the aggressor UE is serviced by a neighboring network node that neighbors the victim network node, as described above.

Process 1700 may include additional aspects, such as any single aspect or any combination of aspects described below and/or in connection with one or more other processes described elsewhere herein.

In a first aspect, the uplink transmission is associated with one or more uplink resources that include CLI measurement resources for one or more inter-UE CLI measurement transmissions from the aggressor UE, SRS resources for one or more SRS transmissions from the aggressor UE, CG resources for one or more CG uplink transmissions from the aggressor UE, uplink resources for an uplink data channel transmission from the aggressor UE, or uplink resources for an uplink reference signal transmission from the aggressor UE.

In a second aspect, process 1700 includes receiving, from the neighboring network node, a PDCCH ordered RACH configuration that indicates transmission of a PRACH signal during a RO, and transmitting, to the victim network node during the RO, the PRACH signal.

In a third aspect, process 1700 includes receiving, from the neighboring network node, a PDCCH ordered RACH configuration that indicates transmission of a PRACH signal during a RO, transmitting, to the victim network node during the RO, the PRACH signal, receiving, from the neighboring network node, a TA command that indicates whether to use a first TA to use for one or more SRS transmissions, where the first TA is based at least in part on a second TA between the aggressor UE and the victim network node and a third TA between the aggressor UE and the neighboring network node, and transmitting, to the victim network node, the uplink transmission in accordance with the first TA.

In a fourth aspect, process 1700 includes receiving, from the neighboring network node, an indication of a sequence to prepend to one or more uplink transmissions, where the sequence is associated with a length that satisfies a length threshold, and where the uplink transmission includes the sequence.

In a fifth aspect, the indication of the sequence comprises a value that points to an index of a CFRA preamble pool that indicates the sequence.

In a sixth aspect, process 1700 includes receiving, from the neighboring network node, control information that schedules a set of SRS repetitions in accordance with the set of active serving reception beams at the victim network node, where the uplink transmission is an SRS repetition of the set of SRS repetition.

In a seventh aspect, process 1700 includes transmitting, to the neighboring network node, an indication of an uplink transmission power associated with the uplink transmission.

In an eighth aspect, process 1700 includes transmitting, to the neighboring network node, an indication of an interference tolerance level associated with the aggressor UE.

In a ninth aspect, the aggressor UE is a CPE.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a network node, or a network node may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 155 described in connection with FIG. 1. As shown, the apparatus 1800 may communicate with another apparatus 1808, such as a UE or a network node (such as a CU, a DU, an RU, or a base station), using the reception component 1802 and the transmission component 1804. The communication manager 1806 may be included in, or implemented via, a processing system (for example, the processing system 145 described in connection with FIG. 1) of the network node.

In some aspects, the apparatus 1800 may be configured to perform one or more operations described herein in connection with FIGS. 3 through 14. Additionally, or alternatively, the apparatus 1800 may be configured to perform one or more processes described herein, such as process 1500 of FIG. 15, process 1600 of FIG. 16, or a combination thereof. In some aspects, the apparatus 1800 and/or one or more components shown in FIG. 18 may include one or more components of the network node described in connection with FIG. 1. Additionally, or alternatively, one or more components shown in FIG. 18 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications, and may provide the processed signals to the one or more other components of the apparatus 1800. In some aspects, the reception component 1802 may include one or more components of the network node described above in connection with FIG. 1, such as a radio, one or more RF chains, one or more transceivers, or one or more modems, each of which may in turn be coupled with one or more antennas of the network node. In some aspects, the reception component 1802 and/or the transmission component 1804 may include or may be included in a network interface. The network interface may be configured to obtain and/or output signals for the apparatus 1800 via one or more communications links, such as a backhaul link, a midhaul link, and/or a fronthaul link.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications, and may transmit the processed signals to the apparatus 1808. In some aspects, the transmission component 1804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1804 may be co-located with the reception component 1802.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

The reception component 1802 may obtain, from a neighboring network node, an indication of uplink resource information associated with an aggressor UE serviced by the neighboring network node. The communication manager 1806 may measure an uplink interference level caused by the aggressor UE in accordance with the uplink resource information.

The reception component 1802 may obtain, from the neighboring network node, an indication of a RO associated with the aggressor UE.

The reception component 1802 may receive, from the aggressor UE during the RO, a PRACH signal, where a first TA between the aggressor UE and the victim network node is calculated in accordance with reception of the PRACH signal.

The reception component 1802 may obtain, from the neighboring network node, an indication of a second TA between the aggressor UE and the neighboring network node.

The communication manager 1806 may measure the uplink interference level caused by the aggressor UE in accordance with a symbol boundary of the aggressor UE, where the symbol boundary is calculated in accordance with a serving cell boundary of the victim network node, the first TA, and the second TA.

The reception component 1802 may obtain, from the neighboring network node, an indication of a RO associated with the aggressor UE.

The reception component 1802 may receive, from the aggressor UE during the RO, a PRACH signal, where a first TA between the aggressor UE and the victim network node is calculated in accordance with reception of the PRACH signal.

The transmission component 1804 may output, to the neighboring network node, an indication of the first TA.

The communication manager 1806 may measure an uplink interference level caused by the aggressor UE in accordance with the first TA.

The communication manager 1806 may communicate, with the neighboring network node, an indication of a sequence to prepend to one or more uplink transmissions, where the sequence is associated with a length that satisfies a length threshold.

The reception component 1802 may receive, from the aggressor UE, an uplink transmission that includes the sequence, where measuring the uplink interference level caused by the aggressor UE is based at least in part on receiving the uplink transmission.

The transmission component 1804 may output, to the neighboring network node, an indication of a set of active serving reception beams at the victim network node, where measuring the uplink interference level caused by the aggressor UE is based at least in part on measuring a set of SRS repetitions respectively associated with a set of transmission beams at the aggressor UE.

The communication manager 1806 may switch from a first reception beam of the set of active reception beams to a second reception beam of the set of active reception beams based at least in part on measuring a set of interference levels respectively associated with the set of SRS repetitions.

The reception component 1802 may receive, from a UE serviced by the victim network node, an uplink transmission via an uplink reception beam, where the uplink reception beam is selected in accordance with the uplink interference level caused by the aggressor UE.

The transmission component 1804 may output, to the neighboring network node, an uplink resource configuration request for the aggressor UE based at least in part on the uplink interference level caused by the aggressor UE.

The reception component 1802 may obtain, from the neighboring network node, an indication of an uplink transmission power of the aggressor UE during measurement of the uplink interference level caused by the aggressor UE.

The communication manager 1806 may determine a pathloss between the aggressor UE and the victim network node based at least in part on the uplink interference level at the victim network node caused by the aggressor UE and the uplink transmission power.

The communication manager 1806 may determine an estimated downlink interference level at the aggressor UE caused by the victim network node based at least in part on a downlink transmission power of the victim network node and the pathloss.

The reception component 1802 may obtain, from the neighboring network node, an indication of a set of downlink resources configured for downlink transmissions from the neighboring network node to the aggressor UE.

The communication manager 1806 may perform, in accordance with the estimated downlink interference level, a downlink transmission power backoff during one or more downlink resources of the set of downlink resources.

The reception component 1802 may obtain, from the neighboring network node, an indication of an interference tolerance level associated with the aggressor UE, where the downlink transmission power backoff satisfies the interference tolerance level.

The transmission component 1804 may output, to a victim network node, an indication of uplink resource information associated with an aggressor UE serviced by the neighboring network node, where the uplink resource information is associated measurement of an uplink interference level caused by the aggressor UE at the victim network node.

The transmission component 1804 may transmit, to the aggressor UE, a PDCCH ordered RACH configuration that indicates for the aggressor UE to transmit a PRACH signal during a RO.

The transmission component 1804 may output, to the victim network node, an indication of the RO.

The transmission component 1804 may output, to the victim network node, an indication of a TA between the aggressor UE and the neighboring network node.

The transmission component 1804 may transmit, to the aggressor UE, a PDCCH ordered RACH configuration that indicates for the aggressor UE to transmit a PRACH signal during a RO.

The transmission component 1804 may output, to the victim network node, an indication of the RO.

The reception component 1802 may obtain, from the victim network node, an indication of the of a first TA between the aggressor UE and the victim network node in accordance with the PRACH signal.

The transmission component 1804 may transmit, to the aggressor UE, a TA command that indicates whether to use a second TA to use for one or more SRS transmissions, where the second TA is based at least in part on the first TA and a third TA between the aggressor UE and the neighboring network node.

The communication manager 1806 may communicate, with the victim network node, a first indication of a sequence to prepend to one or more uplink transmissions, where the sequence is associated with a length that satisfies a length threshold.

The transmission component 1804 may transmit, to the aggressor UE, a second indication of the sequence for the aggressor UE to prepend to one or more uplink transmissions.

The reception component 1802 may obtain, from the victim network node, an indication of a set of active serving reception beams at the victim network node.

The transmission component 1804 may transmit, to the aggressor UE, control information that schedules a set of SRS repetitions in accordance with the set of active serving reception beams at the victim network node.

The reception component 1802 may obtain, from the victim network node, an uplink resource configuration request for the aggressor UE based at least in part on the uplink resource information.

The reception component 1802 may receive, from the aggressor UE, an indication of an uplink transmission power associated with an uplink transmission.

The transmission component 1804 may output, to the victim network node, the indication of the uplink transmission power.

The transmission component 1804 may output, to the victim network node, an indication of a set of downlink resources configured for downlink transmissions to the aggressor UE.

The reception component 1802 may receive, from the aggressor UE, an indication of an interference tolerance level associated with the aggressor UE.

The transmission component 1804 may output, to the victim network node, the indication of the interference tolerance level associated with the aggressor UE.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication, in accordance with the present disclosure. The apparatus 1900 may be a UE, or a UE may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904. The communication manager 1906 may be included in, or implemented via, a processing system (for example, the processing system 140 described in connection with FIG. 1) of the UE.

In some aspects, the apparatus 1900 may be configured to perform one or more operations described herein in connection with FIGS. 3 through 14. Additionally, or alternatively, the apparatus 1900 may be configured to perform one or more processes described herein, such as process 1700 of FIG. 17. In some aspects, the apparatus 1900 and/or one or more components shown in FIG. 19 may include one or more components of the UE described in connection with FIG. 1. Additionally, or alternatively, one or more components shown in FIG. 19 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications, and may provide the processed signals to the one or more other components of the apparatus 1900. In some aspects, the reception component 1902 may include one or more components of the UE described above in connection with FIG. 1, such as a radio, one or more RF chains, one or more transceivers, or one or more modems, each of which may in turn be coupled with one or more antennas of the UE.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications, and may transmit the processed signals to the apparatus 1908. In some aspects, the transmission component 1904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1904 may be co-located with the reception component 1902.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The transmission component 1904 may transmit an uplink transmission associated with determination of an uplink interference level caused by the UE at a victim network node, where the UE is serviced by a neighboring network node that neighbors the victim network node.

The reception component 1902 may receive, from the neighboring network node, a PDCCH ordered RACH configuration that indicates transmission of a PRACH signal during a RO.

The transmission component 1904 may transmit, to the victim network node during the RO, the PRACH signal.

The reception component 1902 may receive, from the neighboring network node, a PDCCH ordered RACH configuration that indicates transmission of a PRACH signal during a RO.

The transmission component 1904 may transmit, to the victim network node during the RO, the PRACH signal.

The reception component 1902 may receive, from the neighboring network node, a TA command that indicates whether to use a first TA to use for one or more SRS transmissions, where the first TA is based at least in part on a second TA between the UE and the victim network node and a third TA between the UE and the neighboring network node.

The transmission component 1904 may transmit, to the victim network node, the uplink transmission in accordance with the first TA.

The reception component 1902 may receive, from the neighboring network node, an indication of a sequence to prepend to one or more uplink transmissions, where the sequence is associated with a length that satisfies a length threshold, and where the uplink transmission includes the sequence.

The reception component 1902 may receive, from the neighboring network node, control information that schedules a set of SRS repetitions in accordance with the set of active serving reception beams at the victim network node, where the uplink transmission is an SRS repetition of the set of SRS repetition.

The transmission component 1904 may transmit, to the neighboring network node, an indication of an uplink transmission power associated with the uplink transmission.

The transmission component 1904 may transmit, to the neighboring network node, an indication of an interference tolerance level associated with the UE.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:

Aspect 1: A method of wireless communication performed by a victim network node, comprising: obtaining, from a neighboring network node, an indication of uplink resource information associated with an aggressor user equipment (UE) serviced by the neighboring network node; and measuring an uplink interference level caused by the aggressor UE in accordance with the uplink resource information.

Aspect 2: The method of Aspect 1, wherein the uplink resource information includes one or more of: cross-link interference (CLI) measurement resources for one or more inter-UE CLI measurement transmissions from the aggressor UE, sounding reference signal (SRS) resources for one or more SRS transmissions from the aggressor UE, configured grant (CG) resources for one or more CG uplink transmissions from the aggressor UE, uplink resources for an uplink data channel transmission from the aggressor UE, or uplink resources for an uplink reference signal transmission from the aggressor UE.

Aspect 3: The method of any of Aspects 1-2, further comprising: obtaining, from the neighboring network node, an indication of a random access channel (RACH) occasion (RO) associated with the aggressor UE; receiving, from the aggressor UE during the RO, a physical RACH (PRACH) signal, wherein a first timing advance (TA) between the aggressor UE and the victim network node is calculated in accordance with reception of the PRACH signal; obtaining, from the neighboring network node, an indication of a second TA between the aggressor UE and the neighboring network node; and measuring the uplink interference level caused by the aggressor UE in accordance with a symbol boundary of the aggressor UE, wherein the symbol boundary is calculated in accordance with a serving cell boundary of the victim network node, the first TA, and the second TA.

Aspect 4: The method of any of Aspects 1-3, further comprising: obtaining, from the neighboring network node, an indication of a random access channel (RACH) occasion (RO) associated with the aggressor UE; receiving, from the aggressor UE during the RO, a physical RACH (PRACH) signal, wherein a first timing advance (TA) between the aggressor UE and the victim network node is calculated in accordance with reception of the PRACH signal; outputting, to the neighboring network node, an indication of the first TA; and measuring an uplink interference level caused by the aggressor UE in accordance with the first TA.

Aspect 5: The method of any of Aspects 1-4, further comprising: communicating, with the neighboring network node, an indication of a sequence to prepend to one or more uplink transmissions, wherein the sequence is associated with a length that satisfies a length threshold; and receiving, from the aggressor UE, an uplink transmission that includes the sequence, wherein measuring the uplink interference level caused by the aggressor UE is based at least in part on receiving the uplink transmission.

Aspect 6: The method of Aspect 5, wherein the indication of the sequence comprises a value that points to an index of a contention-free random access (CFRA) preamble pool that indicates the sequence.

Aspect 7: The method of any of Aspects 1-6, further comprising: outputting, to the neighboring network node, an indication of a set of active serving reception beams at the victim network node, wherein measuring the uplink interference level caused by the aggressor UE is based at least in part on measuring a set of sounding reference signal (SRS) repetitions respectively associated with a set of transmission beams at the aggressor UE.

Aspect 8: The method of Aspect 7, further comprising: switching from a first reception beam of the set of active reception beams to a second reception beam of the set of active reception beams based at least in part on measuring a set of interference levels respectively associated with the set of SRS repetitions.

Aspect 9: The method of any of Aspects 1-8, further comprising: receiving, from a UE serviced by the victim network node, an uplink transmission via an uplink reception beam, wherein the uplink reception beam is selected in accordance with the uplink interference level caused by the aggressor UE.

Aspect 10: The method of any of Aspects 1-9, further comprising: outputting, to the neighboring network node, an uplink resource configuration request for the aggressor UE based at least in part on the uplink interference level caused by the aggressor UE.

Aspect 11: The method of Aspect 10, wherein the uplink resource configuration request indicates one or more of: a first request for the neighboring network node to avoid scheduling the aggressor UE during one or more uplink resources, a second request for the aggressor UE to avoid using one or more associated uplink transmission beams during one or more uplink resources, or a third request for the aggressor UE to reduce an associated output power by a power reduction value.

Aspect 12: The method of any of Aspects 1-11, further comprising: obtaining, from the neighboring network node, an indication of an uplink transmission power of the aggressor UE during measurement of the uplink interference level caused by the aggressor UE; determining a pathloss between the aggressor UE and the victim network node based at least in part on the uplink interference level at the victim network node caused by the aggressor UE and the uplink transmission power; and determining an estimated downlink interference level at the aggressor UE caused by the victim network node based at least in part on a downlink transmission power of the victim network node and the pathloss.

Aspect 13: The method of Aspect 12, further comprising: obtaining, from the neighboring network node, an indication of a set of downlink resources configured for downlink transmissions from the neighboring network node to the aggressor UE; and performing, in accordance with the estimated downlink interference level, a downlink transmission power backoff during one or more downlink resources of the set of downlink resources.

Aspect 14: The method of Aspect 13, further comprising: obtaining, from the neighboring network node, an indication of an interference tolerance level associated with the aggressor UE, wherein the downlink transmission power backoff satisfies the interference tolerance level.

Aspect 15: The method of any of Aspects 1-14, wherein the aggressor UE is a customer premises equipment (CPE).

Aspect 16: A method of wireless communication performed by a neighboring network node, comprising: outputting, to a victim network node, an indication of uplink resource information associated with an aggressor user equipment (UE) serviced by the neighboring network node, wherein the uplink resource information is associated measurement of an uplink interference level caused by the aggressor UE at the victim network node.

Aspect 17: The method of Aspect 16, wherein the uplink resource information includes one or more of: cross-link interference (CLI) measurement resources for one or more inter-UE CLI measurement transmissions from the aggressor UE, sounding reference signal (SRS) resources for one or more SRS transmissions from the aggressor UE, configured grant (CG) resources for one or more CG uplink transmissions from the aggressor UE, uplink resources for an uplink data channel transmission from the aggressor UE, or uplink resources for an uplink reference signal transmission from the aggressor UE.

Aspect 18: The method of any of Aspects 16-17, further comprising: transmitting, to the aggressor UE, a physical downlink control channel (PDCCH) ordered random access channel (RACH) configuration that indicates for the aggressor UE to transmit a physical RACH (PRACH) signal during a RACH occasion (RO); outputting, to the victim network node, an indication of the RO; and outputting, to the victim network node, an indication of a timing advance (TA) between the aggressor UE and the neighboring network node.

Aspect 19: The method of any of Aspects 16-18, further comprising: transmitting, to the aggressor UE, a physical downlink control channel (PDCCH) ordered random access channel (RACH) configuration that indicates for the aggressor UE to transmit a physical RACH (PRACH) signal during a RACH occasion (RO); outputting, to the victim network node, an indication of the RO; and obtaining, from the victim network node, an indication of the of a first timing advance (TA) between the aggressor UE and the victim network node in accordance with the PRACH signal; and transmitting, to the aggressor UE, a TA command that indicates whether to use a second TA to use for one or more sounding reference signal (SRS) transmissions, wherein the second TA is based at least in part on the first TA and a third TA between the aggressor UE and the neighboring network node.

Aspect 20: The method of Aspect 19, wherein the TA command includes one or more bits respectively associated with the one or more SRS transmissions, and wherein the one or more bits respectively indicate whether to use the second TA for an associated SRS transmission.

Aspect 21: The method of any of Aspects 16-20, further comprising: communicating, with the victim network node, a first indication of a sequence to prepend to one or more uplink transmissions, wherein the sequence is associated with a length that satisfies a length threshold; and transmitting, to the aggressor UE, a second indication of the sequence for the aggressor UE to prepend to one or more uplink transmissions.

Aspect 22: The method of Aspect 21, wherein the second indication of the sequence comprises a value that points to an index of a contention-free random access (CFRA) preamble pool that indicates the sequence.

Aspect 23: The method of any of Aspects 16-22, further comprising: obtaining, from the victim network node, an indication of a set of active serving reception beams at the victim network node.

Aspect 24: The method of Aspect 23, further comprising: transmitting, to the aggressor UE, control information that schedules a set of sounding reference signal (SRS) repetitions in accordance with the set of active serving reception beams at the victim network node.

Aspect 25: The method of any of Aspects 16-24, further comprising: obtaining, from the victim network node, an uplink resource configuration request for the aggressor UE based at least in part on the uplink resource information.

Aspect 26: The method of Aspect 25, wherein the uplink resource configuration request indicates one or more of: a first request for the neighboring network node to avoid scheduling the aggressor UE during one or more uplink resources, a second request for the aggressor UE to avoid using one or more associated uplink transmission beams during the one or more uplink resources, or a third request for the aggressor UE to reduce an associated output power by a power reduction value.

Aspect 27: The method of any of Aspects 16-26, further comprising: receiving, from the aggressor UE, an indication of an uplink transmission power associated with an uplink transmission; and outputting, to the victim network node, the indication of the uplink transmission power.

Aspect 28: The method of Aspect 27, further comprising: outputting, to the victim network node, an indication of a set of downlink resources configured for downlink transmissions to the aggressor UE.

Aspect 29: The method of any of Aspects 16-28, further comprising: receiving, from the aggressor UE, an indication of an interference tolerance level associated with the aggressor UE; and outputting, to the victim network node, the indication of the interference tolerance level associated with the aggressor UE.

Aspect 30: The method of any of Aspects 16-29, wherein the aggressor UE is a customer premises equipment (CPE).

Aspect 31: A method of wireless communication performed by an aggressor user equipment (UE), comprising: transmitting an uplink transmission associated with determination of an uplink interference level caused by the aggressor UE at a victim network node, wherein the aggressor UE is serviced by a neighboring network node that neighbors the victim network node.

Aspect 32: The method of Aspect 31, wherein the uplink transmission is associated with one or more uplink resources that include: cross-link interference (CLI) measurement resources for one or more inter-UE CLI measurement transmissions from the aggressor UE, sounding reference signal (SRS) resources for one or more SRS transmissions from the aggressor UE, configured grant (CG) resources for one or more CG uplink transmissions from the aggressor UE, uplink resources for an uplink data channel transmission from the aggressor UE, or uplink resources for an uplink reference signal transmission from the aggressor UE.

Aspect 33: The method of any of Aspects 31-32, further comprising: receiving, from the neighboring network node, a physical downlink control channel (PDCCH) ordered random access channel (RACH) configuration that indicates transmission of a physical RACH (PRACH) signal during a RACH occasion (RO); and transmitting, to the victim network node during the RO, the PRACH signal.

Aspect 34: The method of any of Aspects 31-33, further comprising: receiving, from the neighboring network node, a physical downlink control channel (PDCCH) ordered random access channel (RACH) configuration that indicates transmission of a physical RACH (PRACH) signal during a RACH occasion (RO); transmitting, to the victim network node during the RO, the PRACH signal; receiving, from the neighboring network node, a timing advance (TA) command that indicates whether to use a first TA to use for one or more sounding reference signal (SRS) transmissions, wherein the first TA is based at least in part on a second TA between the aggressor UE and the victim network node and a third TA between the aggressor UE and the neighboring network node; and transmitting, to the victim network node, the uplink transmission in accordance with the first TA.

Aspect 35: The method of any of Aspects 31-34, further comprising: receiving, from the neighboring network node, an indication of a sequence to prepend to one or more uplink transmissions, wherein the sequence is associated with a length that satisfies a length threshold, and wherein the uplink transmission includes the sequence.

Aspect 36: The method of Aspect 35, wherein the indication of the sequence comprises a value that points to an index of a contention-free random access (CFRA) preamble pool that indicates the sequence.

Aspect 37: The method of any of Aspects 31-36, further comprising: receiving, from the neighboring network node, control information that schedules a set of sounding reference signal (SRS) repetitions in accordance with the set of active serving reception beams at the victim network node, wherein the uplink transmission is an SRS repetition of the set of SRS repetition.

Aspect 38: The method of any of Aspects 31-37, further comprising: transmitting, to the neighboring network node, an indication of an uplink transmission power associated with the uplink transmission.

Aspect 39: The method of any of Aspects 31-38, further comprising: transmitting, to the neighboring network node, an indication of an interference tolerance level associated with the aggressor UE.

Aspect 40: The method of any of Aspects 31-39, wherein the aggressor UE is a customer premises equipment (CPE).

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A victim network node for wireless communication, comprising:
one or more memories; and
one or more processors, coupled to the one or more memories, configured to cause the victim network node to:
obtain, from a neighboring network node, an indication of uplink resource information associated with an aggressor user equipment (UE) serviced by the neighboring network node; and
measure an uplink interference level caused by the aggressor UE in accordance with the uplink resource information.

2. The victim network node of claim 1, wherein the uplink resource information includes one or more of:
cross-link interference (CLI) measurement resources for one or more inter-UE CLI measurement transmissions from the aggressor UE,
sounding reference signal (SRS) resources for one or more SRS transmissions from the aggressor UE,
configured grant (CG) resources for one or more CG uplink transmissions from the aggressor UE,
uplink resources for an uplink data channel transmission from the aggressor UE, or
uplink resources for an uplink reference signal transmission from the aggressor UE.

3. The victim network node of claim 1, wherein the one or more processors are further configured to cause the victim network node to:
obtain, from the neighboring network node, an indication of a random access channel (RACH) occasion (RO) associated with the aggressor UE;
receive, from the aggressor UE during the RO, a physical RACH (PRACH) signal, wherein a first timing advance (TA) between the aggressor UE and the victim network node is calculated in accordance with reception of the PRACH signal;
obtain, from the neighboring network node, an indication of a second TA between the aggressor UE and the neighboring network node; and
measure the uplink interference level caused by the aggressor UE in accordance with a symbol boundary of the aggressor UE, wherein the symbol boundary is calculated in accordance with a serving cell boundary of the victim network node, the first TA, and the second TA.

4. The victim network node of claim 1, wherein the one or more processors are further configured to cause the victim network node to:
obtain, from the neighboring network node, an indication of a random access channel (RACH) occasion (RO) associated with the aggressor UE;
receive, from the aggressor UE during the RO, a physical RACH (PRACH) signal, wherein a first timing advance (TA) between the aggressor UE and the victim network node is calculated in accordance with reception of the PRACH signal;
output, to the neighboring network node, an indication of the first TA; and
measure an uplink interference level caused by the aggressor UE in accordance with the first TA.

5. The victim network node of claim 1, wherein the one or more processors are further configured to cause the victim network node to:
communicate, with the neighboring network node, an indication of a sequence to prepend to one or more uplink transmissions, wherein the sequence is associated with a length that satisfies a length threshold; and
receive, from the aggressor UE, an uplink transmission that includes the sequence, wherein measuring the uplink interference level caused by the aggressor UE is based at least in part on receiving the uplink transmission.

6. The victim network node of claim 5, wherein the indication of the sequence comprises a value that points to an index of a contention-free random access (CFRA) preamble pool that indicates the sequence.

7. The victim network node of claim 1, wherein the one or more processors are further configured to cause the victim network node to:
output, to the neighboring network node, an indication of a set of active serving reception beams at the victim network node, wherein measuring the uplink interference level caused by the aggressor UE is based at least in part on measuring a set of sounding reference signal (SRS) repetitions respectively associated with a set of transmission beams at the aggressor UE.

8. The victim network node of claim 7, wherein the one or more processors are further configured to cause the victim network node to:
switch from a first reception beam of the set of active reception beams to a second reception beam of the set of active reception beams based at least in part on measuring a set of interference levels respectively associated with the set of SRS repetitions.

9. The victim network node of claim 1, wherein the one or more processors are further configured to cause the victim network node to:
receive, from a UE serviced by the victim network node, an uplink transmission via an uplink reception beam, wherein the uplink reception beam is selected in accordance with the uplink interference level caused by the aggressor UE.

10. The victim network node of claim 1, wherein the one or more processors are further configured to cause the victim network node to:
output, to the neighboring network node, an uplink resource configuration request for the aggressor UE based at least in part on the uplink interference level caused by the aggressor UE.

11. The victim network node of claim 10, wherein the uplink resource configuration request indicates one or more of:
a first request for the neighboring network node to avoid scheduling the aggressor UE during one or more uplink resources,
a second request for the aggressor UE to avoid using one or more associated uplink transmission beams during one or more uplink resources, or
a third request for the aggressor UE to reduce an associated output power by a power reduction value.

12. The victim network node of claim 1, wherein the one or more processors are further configured to cause the victim network node to:
obtain, from the neighboring network node, an indication of an uplink transmission power of the aggressor UE during measurement of the uplink interference level caused by the aggressor UE;
determine a pathloss between the aggressor UE and the victim network node based at least in part on the uplink interference level at the victim network node caused by the aggressor UE and the uplink transmission power; and
determine an estimated downlink interference level at the aggressor UE caused by the victim network node based at least in part on a downlink transmission power of the victim network node and the pathloss.

13. The victim network node of claim 12, wherein the one or more processors are further configured to cause the victim network node to:
obtain, from the neighboring network node, an indication of a set of downlink resources configured for downlink transmissions from the neighboring network node to the aggressor UE; and
perform, in accordance with the estimated downlink interference level, a downlink transmission power backoff during one or more downlink resources of the set of downlink resources.

14. The victim network node of claim 13, wherein the one or more processors are further configured to cause the victim network node to:
obtain, from the neighboring network node, an indication of an interference tolerance level associated with the aggressor UE, wherein the downlink transmission power backoff satisfies the interference tolerance level.

15. The victim network node of claim 1, wherein the aggressor UE is a customer premises equipment (CPE).

16. A method of wireless communication performed by a victim network node, comprising:
obtaining, from a neighboring network node, an indication of uplink resource information associated with an aggressor user equipment (UE) serviced by the neighboring network node; and
measuring an uplink interference level caused by the aggressor UE in accordance with the uplink resource information.

17. The method of claim 16, wherein the uplink resource information includes one or more of:
cross-link interference (CLI) measurement resources for one or more inter-UE CLI measurement transmissions from the aggressor UE,
sounding reference signal (SRS) resources for one or more SRS transmissions from the aggressor UE,
configured grant (CG) resources for one or more CG uplink transmissions from the aggressor UE,
uplink resources for an uplink data channel transmission from the aggressor UE, or
uplink resources for an uplink reference signal transmission from the aggressor UE.

18. The method of claim 16, further comprising:
obtaining, from the neighboring network node, an indication of a random access channel (RACH) occasion (RO) associated with the aggressor UE;
receiving, from the aggressor UE during the RO, a physical RACH (PRACH) signal, wherein a first timing advance (TA) between the aggressor UE and the victim network node is calculated in accordance with reception of the PRACH signal;
obtaining, from the neighboring network node, an indication of a second TA between the aggressor UE and the neighboring network node; and
measuring the uplink interference level caused by the aggressor UE in accordance with a symbol boundary of the aggressor UE, wherein the symbol boundary is calculated in accordance with a serving cell boundary of the victim network node, the first TA, and the second TA.

19. The method of claim 16, further comprising:
obtaining, from the neighboring network node, an indication of a random access channel (RACH) occasion (RO) associated with the aggressor UE;
receiving, from the aggressor UE during the RO, a physical RACH (PRACH) signal, wherein a first timing advance (TA) between the aggressor UE and the victim network node is calculated in accordance with reception of the PRACH signal;
outputting, to the neighboring network node, an indication of the first TA; and
measuring an uplink interference level caused by the aggressor UE in accordance with the first TA.

20. An apparatus for wireless communication, comprising:
means for obtaining, from a neighboring network node, an indication of uplink resource information associated with an aggressor user equipment (UE) serviced by the neighboring network node; and
means for measuring an uplink interference level caused by the aggressor UE in accordance with the uplink resource information.
